(19) United States
(12) Patent Application Publication
(10) Pub. No.: US 2026/0113677 A1
(43) Pub. Date: Apr. 23, 2026

(54) NTN-TN CONNECTED MODE MOBILITY IN ENERGY SAVING NETWORKS

(71) Applicant: InterDigital Patent Holdings, Inc., Wilmington, DE (US)

(72) Inventors: Umer Salim, Vallauris (FR); Moon IL Lee, Melville, NY (US); Brian Martin, Farnham (GB); Faris Alfarhan, Montreal (CA); Dylan Watts, Montreal (CA); Paul Marinier, Brossard (CA); Jaya Rao, Montreal (CA); Keiichi Kubota, Tokyo (JP)

(73) Assignee: InterDigital Patent Holdings, Inc., Wilmington, DE (US)

(21) Appl. No.: 18/918,622

(22) Filed: Oct. 17, 2024

(51) Int. Cl. H04W 36/08; H04W 36/00; H04W 84/06

(52) U.S. Cl. CPC H04W 36/083; H04W 36/00835; H04W 36/0085; H04W 84/06

(57) ABSTRACT

Systems, methods, and instrumentalities are described herein related to non-terrestrial network (NTN)-terrestrial network (TN) connected mode mobility in energy saving networks. A device (e.g., wireless transmit/receive unit (WTRU)) may perform actions to avoid radio link failures and/or perform connected mode mobility, for example, if cells (e.g., NTN and/or TN) cells are employing energy saving mechanisms. The device may determine and/or wake up suitable cells, for example, if a serving cell is not suitable. The serving cell and a target cell may use different energy saving mechanisms. The device may provide assistance information to a network. The network may wake up suitable cells for the device to monitor and perform mobility.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein related to non-terrestrial network (NTN)-terrestrial network (TN) connected mode mobility in energy saving networks. A device (e.g., wireless transmit/receive unit (WTRU)) may perform actions to avoid radio link failures and/or perform connected mode mobility, for example, if cells (e.g., NTN and/or TN) cells are employing energy saving mechanisms. The device may determine and/or wake up suitable cells, for example, if a serving cell is not suitable. The serving cell and a target cell may use different energy saving mechanisms. The device may provide assistance information to a network. The network may wake up suitable cells for the device to monitor and perform mobility.

An example WTRU may include a processor configured to perform one or more actions. For example, a WTRU may receive configuration information. The configuration information may indicate one or more of the following: a first TN cell, a network energy savings (NES) state associated with the first TN cell, a first reference location associated with the first TN cell, and/or a WUS configuration associated with the first TN cell. The WTRU may determine that a serving cell (e.g., the serving cell to which the WTRU is connected) is not suitable, for example, based on a determination that a first condition is satisfied. The first condition may be associated with one or more of the following: a measurement on a reference signal from the serving cell, an active quality of service (QoS) requirement, a satellite orbit, satellite ephemeris information, a satellite service time, a beam hopping pattern, and/or beam power sharing. The serving cell may include an NTN cell. The WTRU may determine that a first alternate cell is not suitable for handover, for example, based on a determination that a second condition is satisfied. The first alternate cell may be the first TN cell. The WTRU may determine (e.g., based on the determination that the first alternate cell is not suitable for handover) a second alternate cell (e.g., as a candidate alternate cell). The second alternate cell may be a second TN cell. The second alternate cell may be determined based on one or more of the following: WTRU location, a satellite location associated with an NTN cell, a TN cell reference location, NTN cell ephemeris information, an NTN cell NES state, an NTN beam NES state, a TN cell NES state, etc. The WTRU may transmit a wake-up signal (WUS) to the second alternate cell. The WTRU may perform a measurement (e.g., reference signal received power (RSRP) measurement) associated with the second alternate cell. The measurement may be performed within a duration after the transmission of the WUS. The WTRU may determine a third alternate cell, for example, based on the measurement (e.g., RSRP measurement is greater than a threshold). The WTRU may monitor the third alternate cell. The WTRU may send an indication to the serving cell that indicates an identity of the third alternate cell. The WTRU may send an indication to the third alternate cell indicating to stay awake. The WTRU may determine that a third condition is satisfied. The third condition may be associated with the serving cell or the third alternate cell. The WTRU may (e.g., based on the determination that the third condition is satisfied) determine that the third alternate cell is suitable for mobility. The WTRU may perform (e.g., based on the determination that the third alternate cell is suitable for mobility) one or more of: a handover to the third alternate cell; a transmission of an indication to the third alternate cell (e.g., indicating to request a wake-up of the third alternate cell if the third alternate cell is in an NES state); etc.

In examples, the WTRU may determine a WUS configuration. The WUS configuration may be an area-specific WUS configuration. The WUS configuration may be determined based on one or more of a WTRU location, a satellite location with an NTN cell, satellite ephemeris information, a reference location, etc. The WTRU may transmit the WUS using the WUS configuration.

In examples, the WTRU may send assistance information to the serving cell. The WTRU may send assistance information based on a determination that the serving cell is not suitable. The assistance information may include WTRU location information. The WTRU may receive (e.g., from the serving cell, e.g., in response to the assistance information) an indication indicating the second alternate cell. The second alternate cell may be determined based on the indication.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a handover scenario.

FIG. 3 illustrates an example of a Conditional Handover (CHO) configuration and CHO execution.

FIG. 4 illustrates an example of an NTN cell becoming unsuitable while a TN cell is in sleep mode.

FIG. 5 illustrates an example of a procedural flow for NTN-TN connected mode mobility in energy saving networks.

FIG. 6 illustrates an example of a WTRU waking up one or more alternate cells, e.g., using a location-based cell-specific wake-up signal (WUS), and performing mobility to an (e.g., a suitable) alternate cell.

### EXAMPLE NETWORKS FOR IMPLEMENTATION OF THE EMBODIMENTS

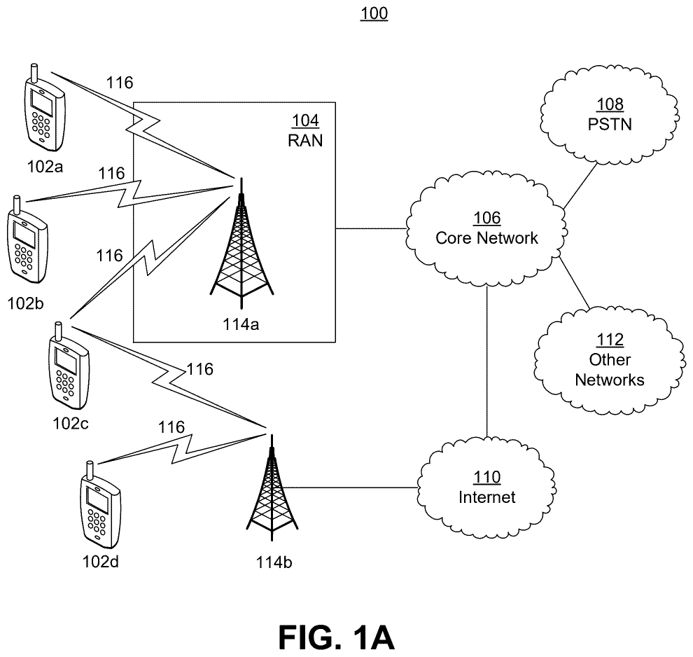

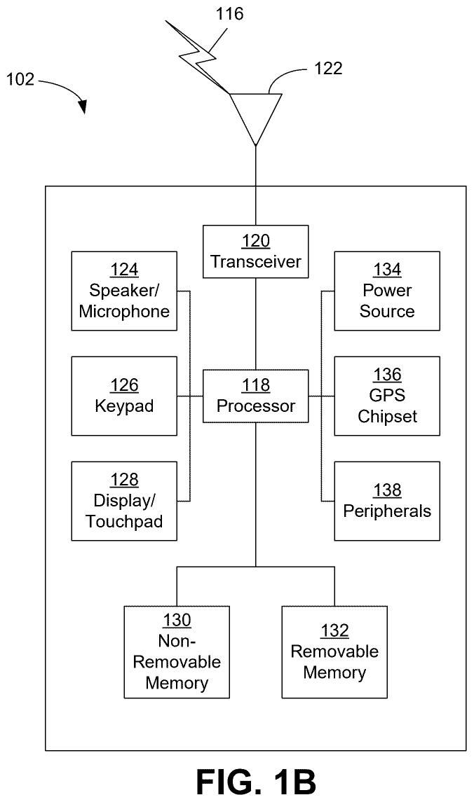

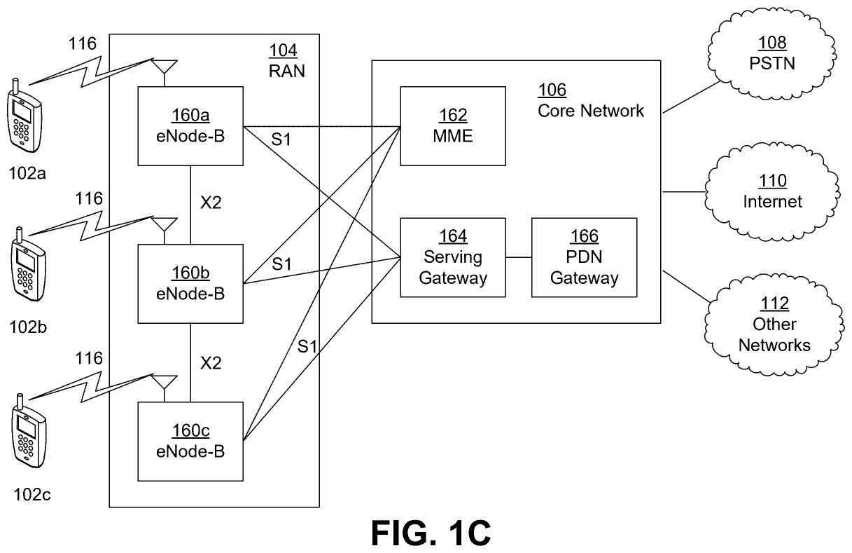

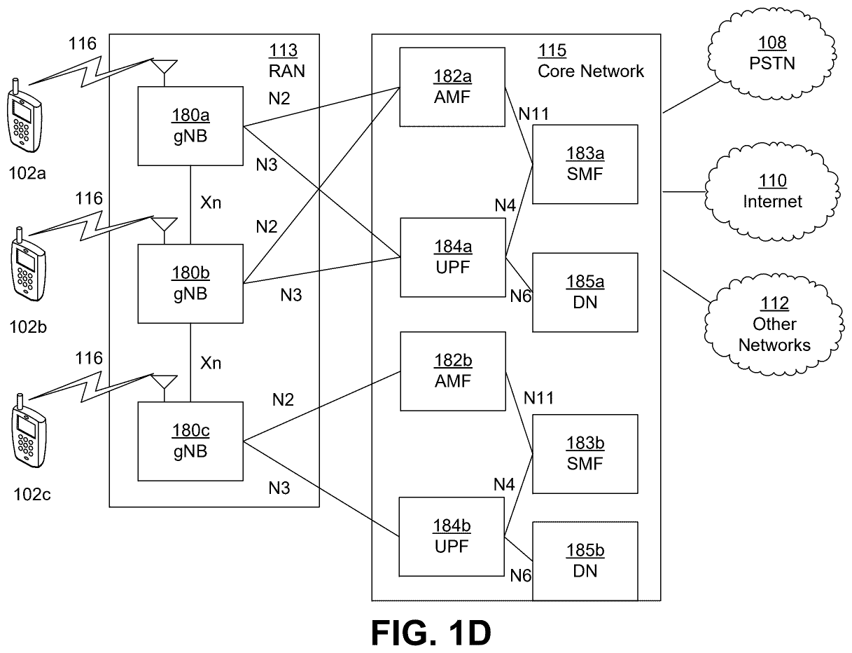

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphoneb 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 106a, 106b, 106c, though it will be appreciated that the RAN 104 may include any number of eNode-Bs while remaining consistent with an embodiment. The eNode-Bs 106a, 106b, 106c may each include one or more transceivers for communicating with the WTRUs 102a, 102b, 102c over the air interface 116. In one embodiment, the eNode-Bs 106a, 106b, 106c may implement MIMO technology. Thus, the eNode-B 160a, for example, may use multiple antennas to transmit wireless signals to, and/or receive wireless signals from, the WTRU 102a.

Each of the eNode-Bs 106a, 106b, 106c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 106a, 106b, 106c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 106a, 106b, 106c. For example, WTRUs 102a, 102b, 102c may implement DC principles to communicate with one or more gNBs 180a, 180b, 180c and one or more eNode-Bs 106a, 106b, 106c substantially simultaneously. In the non-standalone configuration, eNode-Bs 106a, 106b, 106c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein related to non-terrestrial network (NTN)-terrestrial network (TN) connected mode mobility in energy saving networks. Radio link failures may be avoided. Connected mode mobility may be performed, for example, if/when the cells (e.g., NTN and TN cells) employ energy saving mechanisms. A WTRU may determine and wake up suitable cells, for example, if/when the serving cell may not be good enough, e.g., even when the serving cell and the target cells may be using different energy saving mechanisms. In some examples, a WTRU may provide assistance information to the network, which the network may use to wake up suitable cells for the WTRU to monitor and perform mobility.

Systems, methods, and instrumentalities are described herein related to non-terrestrial network (NTN)-terrestrial network (TN) connected mode mobility in energy saving networks. A device (e.g., wireless transmit/receive unit (WTRU)) may perform actions to avoid radio link failures and/or perform connected mode mobility, for example, if cells (e.g., NTN and/or TN) cells are employing energy saving mechanisms. The device may determine and/or wake up suitable cells, for example, if a serving cell is not suitable. The serving cell and a target cell may use different energy saving mechanisms. The device may provide assistance information to a network. The network may wake up suitable cells for the device to monitor and perform mobility.

An example WTRU may include a processor configured to perform one or more actions. For example, a WTRU may receive configuration information. The configuration information may indicate one or more of the following: a first TN cell, a network energy savings (NES) state associated with the first TN cell, a first reference location associated with the first TN cell, and/or a WUS configuration associated with the first TN cell. The WTRU may determine that a serving cell (e.g., the serving cell to which the WTRU is connected) is not suitable, for example, based on a determination that a first condition is satisfied. The first condition may be associated with one or more of the following: a measurement on a reference signal from the serving cell, an active quality of service (QoS) requirement, a satellite orbit, satellite ephemeris information, a satellite service time, a beam hopping pattern, and/or beam power sharing. The serving cell may include an NTN cell. The WTRU may determine that a first alternate cell is not suitable for handover, for example, based on a determination that a second condition is satisfied. The first alternate cell may be the first TN cell. The WTRU may determine (e.g., based on the determination that the first alternate cell is not suitable for handover) a second alternate cell (e.g., as a candidate alternate cell). The second alternate cell may be a second TN cell. The second alternate cell may be determined based on one or more of the following: WTRU location, a satellite location associated with an NTN cell, a TN cell reference location, NTN cell ephemeris information, an NTN cell NES state, an NTN beam NES state, a TN cell NES state, etc. The WTRU may transmit a wake-up signal (WUS) to the second alternate cell. The WTRU may perform a measurement (e.g., reference signal received power (RSRP) measurement) associated with the second alternate cell. The measurement may be performed within a duration after the transmission of the WUS. The WTRU may determine a third alternate cell, for example, based on the measurement (e.g., RSRP measurement is greater than a threshold). The WTRU may monitor the third alternate cell. The WTRU may send an indication to the serving cell that indicates an identity of the third alternate cell. The WTRU may send an indication to the third alternate cell indicating to stay awake. The WTRU may determine that a third condition is satisfied. The third condition may be associated with the serving cell or the third alternate cell. The WTRU may (e.g., based on the determination that the third condition is satisfied) determine that the third alternate cell is suitable for mobility. The WTRU may perform (e.g., based on the determination that the third alternate cell is suitable for mobility) one or more of: a handover to the third alternate cell; a transmission of an indication to the third alternate cell (e.g., indicating to request a wake-up of the third alternate cell if the third alternate cell is in an NES state); etc.

In examples, the WTRU may determine a WUS configuration. The WUS configuration may be an area-specific WUS configuration. The WUS configuration may be determined based on one or more of a WTRU location, a satellite location with an NTN cell, satellite ephemeris information, a reference location, etc. The WTRU may transmit the WUS using the WUS configuration.

In examples, the WTRU may send assistance information to the serving cell. The WTRU may send assistance information based on a determination that the serving cell is not suitable. The assistance information may include WTRU location information. The WTRU may receive (e.g., from the serving cell, e.g., in response to the assistance information) an indication indicating the second alternate cell. The second alternate cell may be determined based on the indication.

A WTRU may determine that a cell is not suitable, for example, based on beam sharing and/or energy saving. A WTRU may provide assistance information to enable cells wake up. A WTRU may autonomously wake up Cells for mobility.

A WTRU may determine that an NTN cell is not suitable. The WTRU may (e.g., based upon the determination that the NTN cell is not suitable) search for a TN cell (e.g., an alternate TN cell) for handover (e.g., by performing mobility related measurements). The WTRU may search for a TN cell that is “stable,” e.g., not in an active network energy saving (NES) state. The WTRU may (e.g., attempt to) measure TN cells that are in an NES state, for example, if the WTRU does not detect a TN cell that is not in a NES state. The WTRU may detect an alternate cell (e.g., a TN or, more generally, a conditional handover (CHO) candidate) satisfying a condition, e.g., a reference signal received power (RSRP) above a threshold.

The WTRU may determine a candidate alternate cell (e.g., a non-stable TN cell), for example, if the WTRU does not detect an (e.g., any) alternate cell. The WTRU may determine a candidate alternate cell (e.g., a non-stable TN cell) based on, for example, one or more of the following: (i) WTRU location, (ii) satellite location, (iii) TN cells reference locations, (iv) NTN cells ephemeris information, (v) NTN cell/beam NES state, and/or (vi) TN cells NES state.

The WTRU (e.g., based on the determination of a candidate alternate TN cell) may transmit an uplink (UL) wake-up signal (WUS), for example, using the UL WUS configuration that may be associated with the selected candidate alternate TN cell.

The WTRU may provide an indication to its NTN primary cell (PCell) about the identity of the alternate TN cell. The WTRU may report that the WTRU did not find a “suitable” alternate cell. The WTRU may request an NTN Power Sharing Rollback, for example, if no alternate cell is found (e.g., No TN cell in proximity).

In some examples, a WTRU may determine a suitable UL-WUS configuration that may be based on (e.g., specific to) one or more of the following: an area, a RAN-based notification area (RNA), a tracking area code (TAC), and/or a public land mobile network (PLMN). The WTRU may send a UL-WUS (e.g., configured to be specific to area, RNA, TAC, and/or PLMN) to wake up one or more neighbor cells.

The WTRU (e.g., based on determining the NTN cell is no longer suitable) may detect an alternate TN cell satisfying a condition, e.g., RSRP is above a certain threshold.

The WTRU (e.g., if the WTRU does not detect an alternate TN cell) may determine a suitable UL-WUS configuration based on, for example, one or more of the following: (i) WTRU location, (ii) satellite location, (iii) satellite ephemeris, (iv) RNA/TAC/PLMN, etc.

The WTRU may transmit a UL WUS signal using, for example, the determined UL WUS configuration.

In some examples, a WTRU (e.g., based on determining that the NTN cell is no longer suitable) may detect an alternate TN cell satisfying a condition, e.g., RSRP is above a certain threshold.

The WTRU (e.g., if the WTRU does not detect an alternate TN cell) may provide an indication to the NTN Cell, e.g., including an indication of the WTRU's location (WTRU location).

The network may (e.g., in response) provide an indication of one or more TN cells for the WTRU to monitor (e.g., through an on-demand reference signal (RS) and/or synchronization signal block (SSB)). The network may provide measurement configurations and/or UL-WUS configuration(s) for the indicated cell(s).

A Non-Terrestrial Network (NTN) may include an aerial or space-borne platform, which (e.g., via a gateway (GW)) may transport signals from a land-based based gNB to a WTRU, and vice-versa. Aerial or space-borne platforms may be classified in terms of orbit. For example, non-geosynchronous orbit (NGSO) satellites may include low-earth orbit (LEO) satellites (e.g., with an altitude range of 300-1500 km) and medium-earth orbit (MEO) satellites (e.g., with altitude range of 7000-25000 km). NGSO satellites may move continuously overhead relative to earth, whereas Geosynchronous orbit (GSO) satellites may remain fixed overhead, e.g., by maintaining an altitude at 35,786 km.

Satellite platforms may be (e.g., further) classified as having a “transparent” or “regenerative” payload. Transparent satellite payloads may implement frequency conversion and/or RF amplification in uplink and/or downlink. In some examples, multiple transparent satellites may be connected to one land-based gNB. Regenerative satellite payloads may implement a full gNB or gNB distributed unit (DU) onboard the satellite. Regenerative payloads may perform digital processing on the signal, which may include demodulation, decoding, re-encoding, re-modulation, and/or filtering.

An NTN satellite may support multiple cells. A (e.g., each) cell may include one or more satellite beams. Satellite beams cover a footprint on Earth (e.g., like a terrestrial cell). The footprint may range in diameter, e.g., 100-1000 km in NGSO deployments and/or 200-3500 km diameter in GSO deployments. Beam footprints in GSO deployments may remain fixed relative to Earth. The area covered by a beam/cell in NGSO deployments may change over time, e.g., due to satellite movement. The beam movement may be classified as “earth moving,” e.g., where the NGSO beam moves continuously across the Earth, or “earth fixed,” e.g., where the beam may be steered to remain covering a fixed location, for example, until a new cell overtakes the coverage area in a discrete and coordinated change.

Operational aspects of non-terrestrial networks may include, for example, one or more of the following: 1) continuous movement of NGSO satellites overhead, which may result in frequent and/or continuous cell change; 2) cell sizes up to 3500 km in diameter; and/or 3) round trip times (RTT) that may be several orders of magnitude larger than terrestrial networks (e.g., up to 541.46 ms).

A network may be an Energy Saving Network that implements network energy savings (NES). A network may be enabled to reduce (e.g., minimize) its power consumption from transmission and/or reception. Power consumption minimization may be beneficial for reducing operational costs and/or environmental sustainability.

Transmissions from a network may be reduced (e.g., minimized), for example, when there is no data. For example, an always-on cell-specific reference signal (CRS) may not be used in a network (e.g., NR). There may be potential for (e.g., additional) energy consumption reduction.

For example, the network may consume energy when not transmitting from other activities, such as baseband (e.g., digital) processing for reception and/or beamforming. Such “idle” power consumption may not be negligible in dense networks, e.g., even when no WTRU is served during a given period. If the network may turn off energy-consuming activities, for example, when not transmitting to a WTRU, e.g., to reduce energy consumption.

A network (e.g., NR, unlike LTE) may not require transmission of always-on synchronization and/or reference signals. A network (e.g., NR, unlike LTE) may support adaptable bandwidth and/or MIMO capabilities. Network resource adaptation(s) may enable greater efficiency in operating newer deployments and later generations.

Channel state information (CSI) may include, for example, at least one of the following: channel quality index (CQI), rank indicator (RI), precoding matrix index (PMI), an L1 channel measurement (e.g., RSRP, such as L1-RSRP, or signal to interference and noise ratio (SINR)), CSI-RS resource indicator (CRI), SS/physical broadcasting channel (PBCH) block resource indicator (SSBRI), layer indicator (LI), and/or any other measurement quantity measured by the WTRU from the configured CSI-RS or SS/PBCH block.

Uplink control information (UCI) may include, for example, at least one of the following: CSI, HARQ feedback for one or more HARQ processes, Scheduling request (SR), Link recovery request (LRR), configured grant uplink control information (CG-UCI), and/or other control information bits that may be transmitted on the physical uplink control channel (PUCCH) or physical uplink shared channel (PUSCH).

Channel conditions may refer to one or more (e.g., any) conditions relating to the state of the radio/channel, which may be determined (e.g., by the WTRU), for example, from one or more of the following: a WTRU measurement (e.g., L1/SINR/RSRP, channel quality indicator (CQI)/modulation and coding scheme (MCS), channel occupancy, received signal strength indicator (RSSI), power headroom, exposure headroom), L3/mobility-based measurements (e.g., RSRP, RSRQ, s-measure), an radio link monitoring (RLM) state, channel availability in unlicensed spectrum (e.g., whether the channel is occupied based on a determination of a listen before talk (LBT) procedure or whether the channel is deemed to have experienced a consistent LBT failure), or any measurement (e.g., as described herein).

A PRACH resource may refer, for example, to one or more of the following: a PRACH resource (e.g., in frequency), a PRACH occasion (RO) (e.g., in time), a preamble format (e.g., in terms of total preamble duration, sequence length, guard time duration, and/or length of cyclic prefix), and/or a (e.g., certain) preamble sequence that may be used for the transmission of a preamble in a random access procedure.

A property of scheduling information (e.g., an uplink grant or a downlink assignment) may include, for example, at least one of the following: a frequency allocation; an aspect of time allocation, such as a duration; a priority; a modulation and coding scheme; a transport block size; a number of spatial layers; a number of transport blocks to be carried; a transmission configuration indication (TCI) state or sounding reference signal (SRS) reference index (SRI); a number of repetitions; grant type (e.g., whether the grant is a configured grant type 1, type 2, or a dynamic grant).

An indication by DCI, or other indication, may include, for example, at least one of the following: an explicit indication (e.g., by a DCI field or by a radio network identifier (RNTI)) that may be used to mask a cyclic redundancy check (CRC) of the PDCCH; an implicit indication by a property, such as DCI format, DCI size, CORESET or search space, aggregation level, identity of first control channel resource (e.g., index of first CCE) for a DCI (e.g., where the mapping between the property and the value may be signaled by radio resource control (RRC) or medium access control (MAC)); and/or an explicit indication by a DL MAC CE.

The terms network availability state, cell turned off, cell discontinuous transmission (DTX) mode/configuration, and NES state may be used interchangeably. The WTRU may determine a cell DTX/DRX state (e.g., implicitly), for example, from a determined active availability state, and visa-versa.

A WTRU may determine whether to transmit/receive on a network based on, for example, network availability states/NES states. A WTRU may determine whether it can transmit or receive on one or more (e.g., certain) resources, for example, depending on a network availability state, which may imply the gNB's power savings status. An availability state may correspond to, for example, one or more of the following: a network energy savings (NES) state, a cell DTX mode, a cell discontinuous reception (DRX) mode, and/or a gNB activity level. An availability state may be uplink and/or downlink specific. An availability state may change from symbol to symbol, slot to slot, frame to frame, and/or on longer duration granularity. An availability state may be determined by a WTRU or indicated by the network. An availability state may include, for example, one or more of the following: “On,” “DL and UL active,” “UL only active,” “off,” “reduced Tx power,” “dormant,” “micro sleep,” “light sleep,” and/or “deep sleep.” The states may be abstracted, for example, by NW configuration parameters and/or values. An indication (e.g., a dynamic indication) may point to the active availability state (e.g., by DCI or MAC CE signaling). The “Off” availability state may imply that the gNB's baseband hardware is completely turned off. The “sleep” availability state may imply that the gNB may wake up periodically to transmit one or more (e.g., certain) signals (e.g., presence signals, synchronization, and/or reference signals) and/or to receive one or more (e.g., certain) UL signals. In one or more (e.g., some) availability states, one or more (e.g., some) DL or UL resources may not be available during one or more (e.g., certain) periods of time, which may enable the network to turn off baseband processing and/or other activities. For example, the WTRU may be configured (e.g., by RRC) with periodic Active and Inactive periods per availability. Some measurement resources (e.g., SSBs or CSI-RS) may be made available (e.g., only) in one or more (e.g., certain) availability states, which may include, for example, one or more of the following: radio link monitoring (RLM), beam failure detection (BFD), radio resource management (RRM) measurements, CSI-RS feedback configuration, and/or a different power offset for CSI feedback.

A WTRU (e.g., under certain conditions) may (e.g., further) transmit a request to the network (e.g., a wake-up request) to modify the availability state to a state associated with resources that may be available for/used by the WTRU (e.g., to satisfy WTRU requirements).

A WTRU may determine an availability state, for example, from reception of an availability state indication, e.g., by L1/L2 signaling, such as a group common DCI or other indication, or (e.g., implicitly) from reception and/or lack of reception of signaling (e.g., periodic DL signaling).

A WTRU may determine if a resource is available for transmission/reception and/or measurements for the determined network availability state, for example, if the resource is applicable in the active availability state. The WTRU may (e.g., also) adapt, for example, one or more of the following: the WTRU's active C-DRX cycle, active spatial elements (e.g., antenna or logical ports), active transmission/reception points (TRPs), paging occasions, etc. The WTRU may perform the adaptation(s), for example, as a function of the signaled or determined availability state. The WTRU may be configured with one or more sets of NES transmission and/or reception parameters per availability state, e.g., by broadcast or dedicated configuration signaling. The WTRU may apply the NES parameter set, for example, according to the determined or signaled availability state. The WTRU may apply one or more applicable configurations, for example, depending on the determined NES state. A set of NES parameters may include, for example, one or more of the following: a number of antenna ports, a C-DRX configuration, a measurement configuration (e.g., for RRM, RLM, and/or beam failure detection (BFD)), CSI feedback, a CSI-RS configuration, an SSB configuration, CHO or mobility candidates, and/or a set of active TRPs.

An availability state may be applicable to at least one transmission, reception, and/or measurement resource. An availability state may be applicable to at least one time period, such as a time slot or time symbol. An availability state may be applicable to, for example, one or more of the following: a serving cell, a cell group, a frequency band, a bandwidth part, a TRP, a set of spatial elements, or a range of frequencies within a bandwidth part. For example, a WTRU (e.g., if/when an NES state changes in a cell) may receive an availability state change indication, which may indicate, for example, that the change is (e.g., only) for that cell, for (e.g., all) cells at the same frequency, or/and the same RAT.

A WTRU may consider the active availability state associated with a cell, carrier, TRP, and/or frequency band to be “Off”, “Deep sleep”, or “Micro sleep,” for example, after reception of a DL signaling that changes the cell's or the TRP's availability state. For example, the WTRU may receive a turn off command on broadcast signaling, RRC signaling, DCI (e.g., a group common DCI), and/or a DL MAC control element (CE) (e.g., indication part of PDSCH). The WTRU may determine an availability state from reception of an availability state indication, which may be received, for example, via L1/L2 signaling (e.g., a group common DCI or indication) or broadcast signaling that may be associated with an availability state.

For example, an availability state change indication may (e.g., also) be part of SI update or SIB signaling (e.g., in a separate SIB that is not read by legacy WTRUs). There may be a common time for (e.g., all) WTRUs in a cell to determine availability state status.

For example, a WTRU may determine a change of NES state change from the reception of group common command L1 signaling (e.g., a group common DCI, a multi-stage DCI, a specific DCI format, and/or a DCI scrambled by a configured or specified NES-specific RNTI). L1 signaling may indicate one or more configured NES parameters sets to apply, or may determine one or more delta configurations from the current set of parameters, e.g., based on determining an NES state change. The WTRU may transmit feedback/acknowledgment to a gNB, which may be multiplexed with UL data (e.g., part of an UL TB as a MAC CE or a subheader indication), for example, following the reception of an NES state change indication.

For example, a WTRU may determine a change of NES state change from the reception of broadcast signaling that may be associated with an NES state indication or change. The broadcast signaling may include, for example, signaling in one or more system information blocks (SIBs) and/or part of a broadcast or multicast PDSCH. The WTRU may be provided with an indication of the NES state, for example, (e.g., explicitly) in the one or more SIBs. The WTRU may be configured with one or more SIBs that may be (e.g., exclusively) associated with a configuration of NES parameters. The WTRU may be configured to receive the broadcast or multicast indication periodically. The WTRU may determine an indication to be mis-detected, for example, if not received on expected periodic occasions, if a number of misdetections is counted, and/or if a timer has elapsed since the last reception of the NES state indication. The WTRU may start inter-cell, inter-frequency, and/or inter-RAT measurements, start a mobility procedure, and/or start evaluating configured CHO candidates, for example, based on (e.g., following) the determination of a misdetection of the NES state indication.

A WTRU may (e.g., implicitly) determine (e.g., assume) an (e.g., a certain) availability state that may be associated with a cell, carrier, TRP, or frequency band (e.g., “Off, “deep sleep,” “micro sleep,” or dormant”) from, for example, at least one of the following: reception of a command or signal indicating a change in availability state; reception of a paging message, paging DCI, paging PDSCH, and/or a paging related signal (e.g., PEI); gNB DTX status; lack of detection of a presence indication; a time; the availability state of an associated cell; detection of a PSS only signal or a simplified/stripped down SSB signal; detection of an RS signal (e.g. CSI-RS, PRS, TRS) or the lack thereof; a WTRU's RRC state; whether paging has been received; whether system information has been received; and/or measured channel condition(s) relative to (e.g., below or above a threshold).

A WTRU may determine an availability state (e.g., associated with a cell, carrier, TRP, or frequency band) based on reception of a command or signal indicating a change in availability state, e.g., a group common DCI in connected mode or RRC signaling or a presence signal. The WTRU may determine an availability state (e.g., implicitly) form the reception of periodic DL signaling. The WTRU may be configured or specified to associate an availability state with one or more DL signal types (e.g., SSB, partial SSB) and/or one or more periodicities.

A WTRU may determine an availability state (e.g., associated with a cell, carrier, TRP, or frequency band) based on reception of a paging message, paging DCI, paging PDSCH, a paging related signal (e.g., PEI), a subset of paging occasions (POs) (e.g., PO(s) aligned with NES DRX cycle or a configured subset of PDCCH resources). The WTRU may determine (e.g., assume) an (e.g., a certain) availability state based on (e.g., after) reception of an indication part of the DCI or PDCCH scheduling paging (e.g., as a function of the P-RNTI, NES-RNTI, or based on receiving an explicit indication, such as on a reserved bit). The WTRU may determine (e.g., assume) an (e.g., a certain) availability state based on (e.g., after) the reception of a paging message with a (e.g., certain) P-RNTI, a (e.g., separately) configured NES P-RNTI, and/or the NES group RNTI. The WTRU may assume an (e.g., a certain) availability state based on (e.g., after) the reception of a paging message with a (e.g., certain) P-RNTI. The WTRU may be configured with one more paging early indication (PEI) subgroups for NES, where a subgroup may be associated with one or more availability states. The WTRU may assume an (e.g., a certain) availability state based on (e.g., after) reception of a PEI with an NES subgroup, for example, if the subgroup is configured and/or associated with the availability state. The indication of the availability state or the availability state switch may be indicated in the paging payload, e.g., as a flag part of the paging message or the short message. The paging indication may (e.g., further) indicate an alternative cell to monitor paging on while the cell from which the signaling was received may be off, asleep, or in an NES state. The paging indication may (e.g., further) indicate or signal applicable reconfiguration parameters (e.g., for initial access, applicable PRACH resources, applicable SSB/RS occasions, applicable SI cycle, and/or the applicable cell(s) and associated availability states).

A WTRU may determine an availability state (e.g., associated with a cell, carrier, TRP, or frequency band) based on a gNB DTX status (e.g., whether the gNB is in active time or an associated activity timer is running).

A WTRU may determine an availability state (e.g., associated with a cell, carrier, TRP, or frequency band) based on lack of detection of a presence indication. For example, a WTRU may determine an availability state associated with a cell (e.g., “off” or “deep sleep”) if a presence indication was not detected on one or more presence indication occasions. For example, a WTRU may determine (e.g., assume or change) the cell's availability state based on (e.g., after) a number of (e.g., consecutive) misdetections and/or after a timer expires following an absence of the detection of a presence signal. The WTRU may determine an availability state is active or de-active, for example, after expiry of a timer that may be associated with the availability state. The timer may be configured and/or maintained in connected mode only or (e.g., also) in one or more other states (e.g., idle and/or inactive states). For example, a WTRU may determine an availability state (e.g., implicitly) from a lack of reception of periodic DL signaling. For example, a WTRU may be configured with a signal quality threshold (e.g., an RSRP threshold). The WTRU may determine (e.g., assume) that an availability state is not active and/or may assume a different availability state, for example, if the WTRU does not detect a signal associated with the availability state (e.g., a presence signal or an SSB) with a signal strength above the signal quality threshold. The criterion may (e.g., also) be based on (e.g., coupled with) a lack of detection of an identifying sequence of the presence signal (e.g., detection of the PSS sequence).

A WTRU may determine an availability state (e.g., associated with a cell, carrier, TRP, or frequency band) based on a time in a day. A WTRU may be configured to determine (e.g., automatically assume) an (e.g., a certain) availability state (e.g., off, sleep, or dormant) for a configured subset of cells (e.g., capacity boosting cells) depending on the time in the day. For example, the WTRU may determine that a capacity boosting cell has an availability state as “On” in one or more (e.g., certain) hours of the day, “Deep sleep” in other configured hours, and “Off” in a third set of configured hours (e.g., of the day or night).

A WTRU may determine an availability state (e.g., associated with a cell, carrier, TRP, or frequency band) based on the availability state of an associated cell (e.g., another carrier of the same MAC entity, another carrier in the same cell group, another carrier in the same gNB, another sector in the same gNB, or a configured associated cell or capacity boosting cell).

A WTRU may determine an availability state (e.g., associated with a cell, carrier, TRP, or frequency band) based on detection of a primary synchronization signal (PSS) only signal or a simplified/stripped down SSB signal.

A WTRU may determine an availability state (e.g., associated with a cell, carrier, TRP, or frequency band) based on detection of an RS signal (e.g., CSI-RS, PRS, TRS) or the lack thereof.

A WTRU may determine an availability state (e.g., associated with a cell, carrier, TRP, or frequency band) based on a WTRU's RRC state (Idle, inactive, or connected mode).

A WTRU may determine an availability state (e.g., associated with a cell, carrier, TRP, or frequency band) based on whether paging has been received, e.g., within a configured time window.

A WTRU may determine an availability state (e.g., associated with a cell, carrier, TRP, or frequency band) based on whether system information (e.g., periodic SI or a subset of SIBs) have been received, e.g., within a configured time window.

A WTRU may determine an availability state (e.g., associated with a cell, carrier, TRP, or frequency band) based on measured channel condition(s) based on a threshold (e.g., below or above a threshold). The WTRU may determine (e.g., assume) a change of an NES state based on a change of measured channel conditions or based on a comparison of a channel measurement to a threshold (e.g., measurement below or above a threshold). For example, the WTRU may use degradation in measurements of SSBs or CSI-RS, e.g., in combination with other signaling, to determine the NES state. For example, a configured window following a DCI reception may be used to measure SSBs and/or CSI-RS for degradation. The WTRU may determine that the NES state has changed, for example, if a delta of SSB-RSRP drop is measured. The WTRU (e.g., based on the NES state change determination) may determine (e.g., assume) associated actions for an NES state (e.g., trigger for CHO candidate selection or for group scheduling for a mobility command).

The WTRU may be configured to monitor an indication that may characterize the level of network activity (e.g., an availability state). The network activity may be associated with a gNB and/or a cell. The WTRU may determine (e.g., assume) the same availability state for (e.g., all) cells that may be part of the same gNB, e.g., cells of the same MAC entity. The network activity indication (e.g., the presence indication) may include a channel (e.g., a PDCCH) and/or a signal (e.g., a sequence). The activity indication or the NES state change indication/command may indicate the level of activity the WTRU may expect from the associated gNB and/or cell, e.g., reduced activity. The activity indication may include activity information of other gNBs/cells. The activity indication may be a PDCCH including group common signaling. For example, the NW may transmit a group common DCI to a group of WTRUs (e.g., WTRUs in the serving cell) indicating a change of an activity state or activity level in UL and/or DL. The CRC of the PDCCH may be scrambled with a dedicated “activity indication RNTI or an NES-RNTI. A WTRU may be configured with at least one search space that may be associated with the monitoring occasions of the activity indication PDCCH. The indication may include a go-to-sleep signal, e.g., a predefined sequence. The WTRU (e.g., when the WTRU detects the sequence) may determine (e.g., expect) a reduced activity level over a (e.g., specific) time duration. The WTRU may activate C-DRX for the period of time indicated. In some (e.g., alternative) examples, multiple (e.g., two) sequences may be used to indicate different activity levels (e.g., regular activity and/or reduced activity levels).

The signaling within the PDCCH and/or the activity indication may include, for example, at least one of the following: an expected activity level of the associated gNBs/cells over a (e.g., specific) time interval (e.g., an availability state); a definition of transmission and/or reception attributes, for example, for an (e.g., each) activity level (e.g., availability state); an association of a set of configurations with an activity level, which may be used/applied when the activity level is indicated (e.g., an NES parameter set); a time interval over which an activity level may be determined (e.g., assumed), which may be signaled in the PDCCH or part of the activity indication; and/or a time interval over which an activity level may be determined (e.g., assumed).

The signaling within the PDCCH and/or the activity indication may include an expected activity level of the associated gNBs/cells over a (e.g., specific) time interval (e.g., an availability state). The activity levels may be (pre)determined and/or configured. The activity levels may include, for example, regular and/or reduced activity. The signaling may indicate the activity level. For example, bit “1” may indicate regular activity and bit “0” may indicate reduced activity.

The signaling within the PDCCH and/or the activity indication may include a definition of transmission and/or reception attributes, for example, for an (e.g., each) activity level (e.g., availability state). For example (e.g., during reduced activity), a WTRU may not (e.g., be expected to) monitor one or more (e.g., certain) PDCCH search spaces (e.g., including all SSs), receive one or more (e.g., certain) types of PDSCH (e.g., including all PDSCHs), transmit PUCCH/PUSCH, and/or perform one or more (e.g., certain) measurements. The WTRU may start or stop monitoring PDCCH and/or TCI states associated with a determined NES state, e.g., including PDCCH resources or TCI states that may be associated with (de)activated TRPs or spatial elements.

The signaling within the PDCCH and/or the activity indication may include an association of a set of configurations with an activity level, which may be used/applied, for example, if/when the activity level is indicated (e.g., an NES parameter set). A set of configurations may include, for example, SS configurations, CSI reporting configurations, indices of transmitted SSBs, etc. A (e.g., each) set of configurations may have an attribute associated with an activity level, e.g., a tag that can be set to “reduced activity.”

The signaling within the PDCCH and/or the activity indication may include a time interval over which an activity level may be determined (e.g., assumed), which may be signaled in the PDCCH or part of the activity indication. The time interval may be indicated, for example, using a bitmap. A (e.g., each) bit in the bitmap may be associated with a (e.g., specific) duration, e.g., a slot or a frame. For example, bit “1” may indicate regular activity and bit “0” may indicate reduced activity on an associated frame. The time interval may be indicated, for example, with a start time and length of interval. The start time may be defined. For example, the start time may be determined by adding a fixed offset to the time the indication is received. The length of the interval may be configured or signaled in the indication PDCCH.

The signaling within the PDCCH and/or the activity indication may include a time interval over which an activity level may be determined (e.g., assumed). The WTRU may determine (e.g., assume) an interruption delay (e.g., or, more generally, a time until the NES state changes), for example, based on (e.g., after) the NES state change command reception (e.g., after the last symbol or slot on which the command was received). The interruption time may be, for example, in absolute time, a number of symbols, or a number of slots.

The WTRU may determine that an uplink or downlink resource or signal is available for transmission/reception and/or measurements for the determined network availability state, for example, if the uplink or downlink resource or signal is applicable in the active availability state. The WTRU may determine that a subset of measurement resources and/or signals (e.g., SSBs, CSI-RS, TRS, PRS) are not applicable in one or more (e.g., certain) availability states. The WTRU may determine that a subset of uplink or downlink resources (e.g., PRACH, PUSCH, PUCCH) are not applicable in one or more (e.g., certain) availability states. The WTRU may transmit one or more (e.g., some) uplink signals (e.g., only) in a subset of NW availability states (e.g., SRS, pSRS, PRACH, UCI).

A WTRU may be receive an indication of and/or may determine one or more NES alternative cells. A WTRU may perform cell (re)-selection, mobility to another serving cell, trigger mobility related measurements, and/or start evaluating CHO candidates on alternate cells, for example, based on a determination that there may be an NES change on the camped cell or the serving cell. The WTRU may be configured or (pre)defined with an alternative serving cell to perform initial access, mobility, and/or cell reselection on, for example, in the event the current serving cell and/or a capacity boosting cell (e.g., a cell not configured as an alternative cell) is turned off or one or more (e.g., certain) conditions are met. The WTRU may be configured (e.g., per broadcast or dedicated signaling) with a list of fallback or alternative serving cells, e.g., per serving cell, per gNB, per PLMN, and/or per network identity.

In some examples, the WTRU may initiate a cell reselection or mobility procedure to an alternative serving cell associated with a cell or gNB from which a turn-off indication was received. In some examples, the turn off or go-to-sleep indication may (e.g., dynamically) indicate to the WTRU which cell to fallback or connect to, e.g., by dedicated or broadcast signaling. The fallback/alternative cell may be configured or (pre)defined to be a cell within the same gNB from which a sector has entered NES state (e.g., off, sleep, or reduced power). In some examples, the fallback cell may be predefined as the master node cell, e.g., if the WTRU is in dual connectivity. The fallback/alternative cell may be configured or (pre)defined to be a cell associated with a different RAT or frequency band. For example, the WTRU may fallback to an LTE or a frequency range one (1) (FR1) cell that may be associated with the cell or gNB from which the turn off indication was received (e.g., if the WTRU is in carrier aggregation (CA) or dual connectivity (DC) using multiple RATs or multiple frequency bands).

The terms alternative cell and stable cell may be used interchangeably. The WTRU may be configured with a list of stable cells (e.g., alternative cells that may not turn off, such as some macro cells). The list may be, for example, a list of alternative cells per serving/camped cell or a general list of physical cell identities (PCIs) for the (e.g., whole) NW, Tracking area, etc. The WTRU may be configured with measurement object configuration for the alternative cells. Alternative cells may be preconfigured to be conditional handover (CHO) candidates. Alternative cells may be considered as CHO candidates, for example, (e.g., only) if the source cell turns off/activates NES.

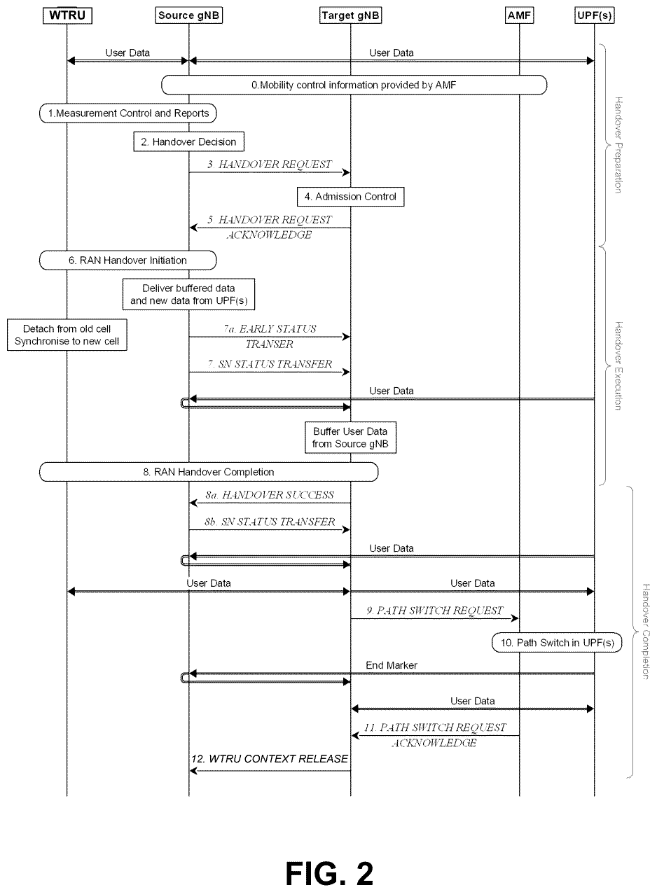

A WTRU may have Connected Mode mobility. For example, a WTRU may participate in a handover. An example of a handover scenario (e.g., in NR) is shown in FIG. 2.

FIG. 2 illustrates an example of a handover scenario.

As shown in FIG. 2, at 0, the WTRU context within the source gNB may include information regarding roaming and access restrictions, which may have been provided at connection establishment or at a (e.g., the last) Timing Advance (TA) update.

At 1 in FIG. 2, the source gNB may configure the WTRU measurement procedures. The WTRU may report according to the measurement configuration.

At 2 in FIG. 2, the source gNB may (e.g., decide to) handover the WTRU, for example, based on the received measurements.

At 3 in FIG. 2, the source gNB may issue a Handover Request message to the target gNB. The handover request may include/pass, for example, a transparent RRC container with (e.g., necessary) information to prepare the handover at the target side. The information may include, for example, one or more of the following: the target cell ID, new session key (KgNB*), the cell radio network identifier (C-RNTI) of the WTRU in the source gNB, radio resource management (RRM) configuration (e.g., including WTRU inactive time), (e.g., basic) access stratum (AS) configuration (e.g., including antenna information and/or DL Carrier Frequency), the current QoS flow to data radio bearer (DRB) mapping rules applied to the WTRU, the system information block one (1) (SIB1) from the source gNB, the WTRU capabilities for different RATs, PDU session related information, and/or the WTRU reported measurement information (e.g., including beam-related information, if available).

At 4 in FIG. 2, Admission Control may be performed by the target gNB.

At 5 in FIG. 2, the target gNB may prepare the handover with L1/L2, for example, if the WTRU can be admitted. The target gNB may send a HANDOVER REQUEST ACKNOWLEDGE to the source gNB, which may include a transparent container (e.g., sent to the WTRU as an RRC message) to perform the handover.

At 6 in FIG. 2, the source gNB triggers the Uu handover by sending an RRCReconfiguration message to the WTRU, which may include information useful (e.g., required) to access the target cell.

Information in the message may include, for example, one or more of the following: the target cell ID, the new C-RNTI, the target gNB security algorithm identifiers for the selected security algorithms, a set of dedicated RACH resources, the association between RACH resources and SSB(s), the association between RACH resources and WTRU-specific CSI-RS configuration(s), common RACH resources, system information of the target cell, etc.

At 7 in FIG. 2, the source gNB may send an SN STATUS TRANSFER message to the target gNB to convey the uplink packet data convergence protocol (PDCP) sequence number (SN) receiver status and/or the downlink PDCP SN transmitter status of data radio bearers (DRBs) for which PDCP status preservation applies (e.g., for radio link control acknowledged mode (RLC AM)).

At 8 in FIG. 2, the WTRU may synchronize to the target cell. The WTRU may complete the RRC handover procedure, for example, by sending an RRCReconfigurationComplete message to the target gNB.

At 9 in FIG. 2, the target gNB may send a PATH SWITCH REQUEST message to the access and mobility function (AMF), e.g., to trigger the network (e.g., 5G core network (5GC)) to switch the DL data path towards the target gNB and to establish a core network (e.g., an NG-C) interface instance towards the target gNB.

At 10 in FIG. 2, the core network (e.g., 5GC) may switch the DL data path towards the target gNB. The user plane function (UPF) may send one or more “end marker” packets on the old path to the source gNB per PDU session/tunnel. The UPF may (e.g., then) release any U-plane/TNL resources towards the source gNB.

At 11 in FIG. 2, the AMF may confirm the PATH SWITCH REQUEST message with the PATH SWITCH REQUEST ACKNOWLEDGE message.

At 12 in FIG. 2, the target gNB may receive the PATH SWITCH REQUEST ACKNOWLEDGE message from the AMF. The target gNB may (e.g., in response to receiving the message) send the WTRU CONTEXT RELEASE to inform the source gNB about the success of the handover. The source gNB may (e.g., then) release radio and/or C-plane related resources that may be associated with the WTRU context. Any ongoing data forwarding may continue.

A conditional HO (CHO) and/or a conditional PSCell change (CPC) may occur in a network (e.g., in NR). A CHO and/or a conditional PSCell Addition/Change (CPA/CPC, collectively referred to as CPAC) may reduce the likelihood of radio link failures (RLF) and/or handover failures (HOF).

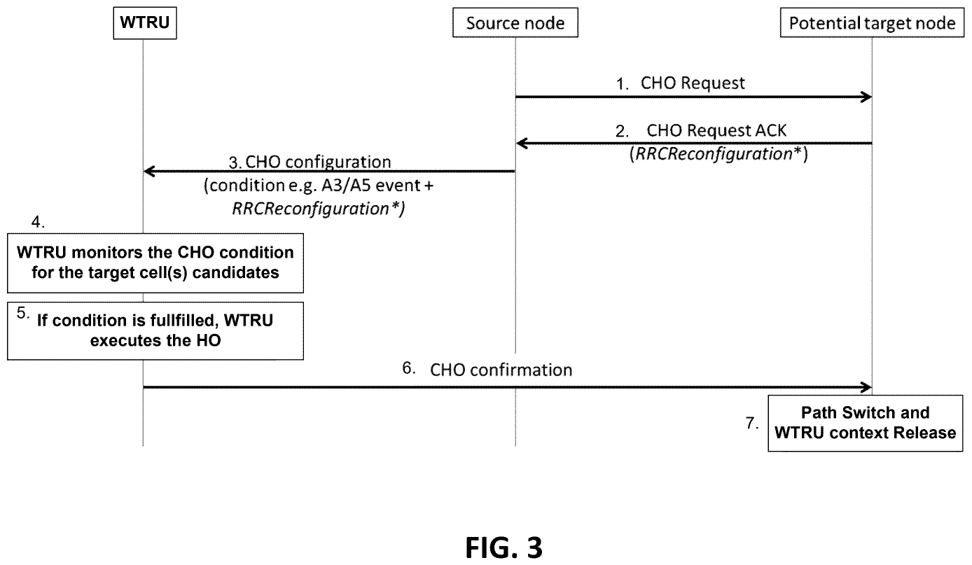

A handover (e.g., a legacy LTE/NR handover) may be triggered, for example, by measurement reports. The network may (e.g., also) send an HO command to a WTRU without receiving a measurement report. For example, a WTRU may be configured with an A3 event that triggers a measurement report to be sent when the radio signal level/quality (e.g., RSRP, RSRQ, etc.) of a neighbor cell becomes better than the Primary serving cell (PCell) and/or (e.g., also) the Primary Secondary serving Cell (PSCell), e.g., in the case of Dual Connectivity (DC). The WTRU may monitor the serving and neighbor cells. The WTRU may send a measurement report, for example, if/when the conditions get fulfilled. The network (e.g., current serving node/cell) may (e.g., if/when a report is received) prepare the HO command (e.g., an RRC Reconfiguration message, with a reconfigurationWithSync). The network may send the HO command to the WTRU. The WTRU may execute the HO command (e.g., immediately), which may result in the WTRU connecting to the target cell. FIG. 3 shows an example of a conditional handover (CHO) configuration and CHO execution in a network (e.g., in NR).

FIG. 3 illustrates an example of a Conditional Handover (CHO) configuration and CHO execution. As shown in FIG. 3 at 1, a CHO request may be sent, for example, from a source node to a potential target node. As shown in FIG. 3 at 2, a CHO request ACK (e.g., RRCReconfiguration) may be received, for example, at a source node from the potential target node. As shown in FIG. 3 at 3, the source node may send CHO configuration information (e.g., based on a condition, such as, A3/A5 event and/or RRCconfiguration). As shown in FIG. 3 at 4, the WTRU may monitor the CHO condition for the target cell(s) candidates. As shown in FIG. 3 at 5, the WTRU may execute the HO, for example, if the condition is fulfilled. As shown in FIG. 3 at 6, a CHO confirmation may be sent, for example, from the WTRU to the potential target node. As shown in FIG. 3 at 7, the potential target node may perform a path switch and/or WTRU context release.

CHO may differ from a (e.g., legacy) handover (HO) in one or more aspects. A CHO may involve preparation of one or multiple handover targets, for example, as compared to (e.g., only) one target in a (e.g., legacy) HO. A WTRU may not (e.g., immediately) execute a CHO, for example, as compared to (e.g., legacy) handover (HO) execution. A WTRU may be configured with one or more triggering conditions (e.g., a set of radio conditions) for a CHO. The WTRU may execute a handover towards one of the CHO targets, for example, (e.g., only) if/when the triggering conditions are fulfilled.

A CHO command may be sent, for example, if/when the radio conditions towards the current serving cells are (e.g., still) favorable, which may reduce one or more points of failure in a (e.g., legacy) handover, such as a risk of failing to send the measurement report (e.g., if the link quality to the current serving cell falls below acceptable levels when the measurement reports are triggered in normal handover) and/or a risk of failing to receive the handover command (e.g., if the link quality to the current serving cell falls below acceptable levels after the WTRU has sent the measurement report, but before the WTRU has received the HO command).

The triggering conditions for a CHO may (e.g., also) be based on the radio quality of the serving cells and/or neighbor cells, e.g., similar to the conditions that may be used (e.g., in legacy NR/LTE) to trigger measurement reports. For example, a WTRU may be configured with a CHO that has one or more (e.g., an A3 like) triggering conditions and an associated HO command. The WTRU may monitor the current and serving cells. The WTRU may executes the associated HO command and switches its connection towards the target cell (e.g., instead of sending a measurement report), for example, if/when the (e.g., A3) triggering conditions are fulfilled.

CHO may (e.g., also) help prevent unnecessary re-establishments, e.g., in case of a radio link failure. For example, a WTRU may be configured with multiple CHO targets. The WTRU may experience an RLF before the triggering conditions with (e.g., any of) the targets may be fulfilled. In some examples (e.g., legacy operation), an RRC re-establishment procedure may occur based on the RLF. An RRC re-establishment procedure may incur considerable interruption time for the bearers of the WTRU. A WTRU configured with a CHO may avoid a full re-establishment procedure. For example, a WTRU (e.g., configured with CHO) may (e.g., after detecting an RLF) end up in a cell for which the WTRU has an associated CHO (e.g., the target cell is already prepared for the WTRU). The WTRU may execute a HO command associated with the target cell directly, for example, instead of continuing with a full re-establishment procedure.

CPC and CPA may be extensions of CHO, but in DC scenarios. A WTRU may be configured with triggering conditions for PSCell change or addition. A WTRU (e.g., configured with one or more trigger conditions) may execute the associated PSCell change or PSCell add commands, for example, if/when the triggering conditions are fulfilled.

Mobility may occur in overlaid coverage of Terrestrial Network (TN) and Non-Terrestrial Network (NTN) cells. Mobility may occur between NTN and TN cells at TN coverage boundaries. TN cells may be a frontier to NTN in energy saving mode (e.g., limited number of WTRUs under coverage of the TN cells). NTN cells may utilize beam hopping or power reduction, e.g., due to hardware/power limitations. WTRUs may be capable of operation on an air interface (Uu) and on an NTN.

Mobility may occur between NTN and TN cells in sleep mode.

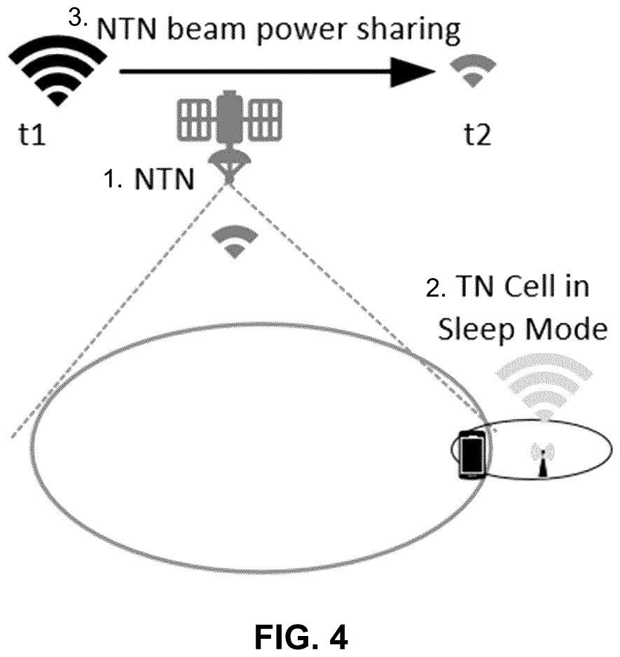

FIG. 4 illustrates an example of an NTN cell becoming unsuitable while a TN cell is in sleep mode.

As shown by example in FIG. 4, an NTN cell/beam (e.g., as shown at 1 in FIG. 4) may apply power sharing mechanisms (e.g., as shown at 3 in FIG. 4), making it unsuitable for connected mode WTRU operation. The connected mode WTRU may be under the coverage of one or more frontier TN cells, which may be in deep sleep (e.g., as shown at 2 in FIG. 4). Fully overlaid coverage may (e.g., also) be possible with sleeping TN cells.

NTN-TN mobility may be implemented for WTRUs in connected mode. Cells may operate in normal mode, which may permit WTRUs to detect, measure, and/or report the cells. Mobility mechanisms may not work if the cells are asleep.

A network may wake up an excessive number of sleeping neighbor TN cells. For example, there may be dozens/hundreds of cells neighboring a single NTN beam, which may make waking up sleeping neighbor cells (e.g., very) sub-optimal, e.g., from an energy conservation perspective.

NTN-TN WTRU connected mode mobility mechanisms in energy saving networks may involve one or more of the following aspects.

A WTRU may detect that the WTRU is in-coverage of a sleeping TN cell. The NW may not know (e.g., precisely) when an NTN WTRU is in sufficient coverage of a sleeping TN Target cell. A WTRU may determine a TN cell to be in close enough proximity when the TN cell is in NES mode (e.g., power adaptation, Cell DTX, SSB only, no SSB transmission).

A WTRU may assist the network or initiate (e.g., direct) wake-up of a sleeping TN cell, for example, based on a detection that the WTRU's current NTN cell may be becoming unsuitable, e.g., due to beam hopping or power sharing. The Network may wake up (e.g., suitable) sleeping TN cells for connected mode mobility, for example, based upon WTRU assistance information (e.g., without WTRU assistance, the Network may wake up dozens/hundreds of TN cells given the large coverage of NTN). A WTRU may wake up (e.g., suitable) sleeping TN cells for connected mode mobility, for example, based on a network configuration.

A WTRU may combine one or more of the following: (i) WTRU location, (ii) satellite location, (iii) time, (iv) TN NES mode, (v) NTN power sharing to handle mobility scenarios encompassing NTN to NTN, TN to NTN, and/or NTN to TN. Some (e.g., legacy) location and/or time based (CHO) triggers may be ineffective without (e.g., proper) inclusion of power saving and/or power sharing employed by TN/NTN cells.

A WTRU may request that an NTN cell modify/update its beam-hopping and/or power sharing. A WTRU may fall back if a TN cell is not found.

A WTRU may assist the network or initiate (e.g., direct) wake-up of a suitable sleeping TN cell for a mobility (e.g., HO/CHO) purpose, for example, based on a detection of the WTRU's current NTN cell becoming unsuitable, e.g., due to beam hopping or power sharing.

A WTRU may wake up an Alternate Cell, for example, to avoid an RLF over an NTN.

A WTRU may wake up an alternate cell using, for example, a location based cell specific WUS, e.g., based on a detection of NTN power sharing.

A WTRU may be connected to a serving cell. For example, the WTRU may be connected to a serving cell that is an NTN cell. A WTRU connected to an NTN cell may be configured with, for example, one or more of the following: an NTN power sharing mechanism, a set of neighbor TN cells, associated WUS configurations, and/or mobility/CHO configurations for neighboring TN cells. The WTRU may be configured with an associated NES state, a reference location, and/or a UL WUS configuration, for example, for a (e.g., each) TN cell. A WTRU (e.g., upon detecting an NTN cell applying beam hopping/power sharing) may determine one or more candidate alternate TN cells to monitor, for example, based on one or more of the following: (i) WTRU location, (ii) satellite location/ephemeris, (iii) TN cells reference locations, (iv) NTN cell NES state, (v) TN cells NES states, and/or (vi) measurement of channel conditions of neighbor cells (e.g., TN cells). The WTRU may wake up the selected candidate alternate TN cell, for example, by transmitting a UL-WUS according to the received configuration. The WTRU may make measurements on the (e.g., on-demand) SSBs (e.g., RSs) from the candidate alternate cell. The WTRU may (e.g., start to) monitor for a potential cell switch. The WTRU may perform mobility (e.g., HO/CHO) to the alternate cell, for example, based on a condition, e.g., HO/CHO conditions being fulfilled.

A WTRU may receive a configuration and/or configuration information. A WTRU (e.g., connected to an NTN cell) may be configured, for example, with one or more of the following: a beam hopping/power sharing indication configuration for an NTN cell; a set of CHO configurations for TN cells with their NES states, measurement configuration, and/or reference locations; and/or a set of UL-WUS configurations that may be associated with one or more of the neighbour TN cells or WTRU locations, or the satellite location/ephemeris, etc. For example, the configuration information may indicate a first TN network. The configuration information may indicate one or more of an NES state associated with the first TN cell, a first reference location associated with the first TN cell, and/or a WUS configuration associated with the first TN cell.

A WTRU (e.g., connected to an NTN cell) may be configured with a beam hopping/power sharing indication configuration for an NTN cell.

A WTRU (e.g., connected to an NTN cell) may be configured with a set of CHO configurations for TN cells with their NES states, measurement configuration, and/or reference locations. The WTRU may know a subset of TN cells that may be “stable” (e.g., TN cells that may not be in an NES state). Stable cells may be configured as CHO candidates. The WTRU may measure the stable cells (e.g., first) prior to measuring other TN cells that are “not stable” “unstable.”

A WTRU (e.g., connected to an NTN cell) may be configured with a set of UL-WUS configurations that may be associated with one or more of the neighbor TN cells or WTRU locations, or the satellite location/ephemeris, etc.

A WTRU may detect whether an NTN Cell is or is not suitable. For example, the WTRU may determine that a serving cell is not suitable based on a determination that a condition is satisfied. The WTRU may detect the NTN cell undergoing a beam hopping/power sharing state (e.g., satisfying a condition). Implicit detection may be based on detecting a change in a measurement or one of the physical properties of signal, for example, an SSB and/or other signals. Explicit detection may be based on, for example, a NW indication, e.g., through PHY/MAC/RRC signalling.

The WTRU may determine the NTN cell becoming unsuitable (e.g., (a) now, (b) within a window of length T1, (c) after a duration T2) based on, for example, one or more of the following: (i) active QoS requirements, (ii) satellite orbit, (iii) satellite ephemeris, (iv) satellite service time, (v) detected Beam hopping pattern (e.g., periodicity larger than a threshold, active time of the beam serving the WTRU smaller than a threshold, etc), (vi) detected beam power sharing (e.g., power reduction of the satellite beams larger than a threshold, etc), (vii) a measurement on a reference signal from the serving cell.

A WTRU may monitor an alternate (e.g., first alternate) TN cell (e.g., WTRU autonomous wake up of alternate cell). For example, a WTRU (e.g., based on a determination that an NTN cell may be unsuitable) may (e.g., first) search for a first alternate TN cell for handover (e.g., by performing mobility related measurements) that may be “stable,” e.g., not in an active NES state. The WTRU may attempt to measure TN cells that are in an NES state, for example, if the WTRU does not detect a first alternate TN cell that is not in an NES state For example, the WTRU may determine that a first alternate cell is not suitable for handover. The WTRU may determine that the first alternate cell is not suitable for handover based on a determination that a second condition is satisfied. The first alternate cell may include the first TN cell (e.g., as indicated by configuration information).

The WTRU (e.g., if the WTRU does not detect a first alternate cell) may determine a second alternate (e.g., candidate alternate) cell (e.g., a non-stable TN cell), for example, based on one or more of the following: (i) WTRU location, (ii) satellite location, (iii) TN cells reference locations, (iv) NTN cells ephemeris information, (v) NTN cell/beam NES state, and/or (vi) TN cells NES state. A TN cell reference location may be the TRP location for the TN cell, geographic centre of the TN cell coverage, or a suitable location where the coverage of the TN cell may start to become reliable.

The WTRU (e.g., based on the determination of a second alternate (e.g., candidate alternate) TN cell) may transmit a UL WUS signal, e.g., using the UL WUS configuration that may be associated with the selected candidate alternate TN cell. The WTRU may send the UL WUS signal to the second alternate cell (e.g., candidate alternate cell). The WTRU may determine the UL WUS configuration, for example, based on one or more of a WTRU location, a satellite location associated with an NTN cell, satellite ephemeris information, or a reference location. The WUS configuration may be an area-specific WUS configuration.

The WTRU (e.g., within a window T after UL WUS transmission) may detect/perform measurements over the on-demand RS/SSBs from the second alternate cell (e.g., candidate alternate cell).

The WTRU (e.g., based on the measurements) may select an alternate TN cell (e.g., third alternate cell) that satisfies one or more conditions, e.g., RSRP/RSRQ is above a certain threshold.

The WTRU may provide an indication to the third alternate TN cell to stay awake.

The WTRU may provide an indication to its serving about the identity of the third alternate TN cell.

The WTRU may, e.g., alternatively, report that the WTRU did not find a “suitable” alternate cell. The WTRU may request NTN Power Sharing Rollback, for example, if the WTRU did not find an alternate cell. The WTRU may not find a suitable alternate cell, for example, if there is not a TN cell in proximity of the WTRU.

The WTRU may (e.g., start to) monitor the third alternate TN cell.

The WTRU may perform a cell switch from the NTN to the third alternate TN Cell. The WTRU may determine that the third alternate TN cell is suitable for mobility (e.g., HO/CHO), for example, based on a determination that a third condition (e.g., associated with the serving cell or the third alternate cell) is satisfied. The WTRU may determine that the third alternate TN cell is suitable for mobility (e.g., HO/CHO), for example, based on one or more conditions being fulfilled, e.g., (i) NTN cell RSRP measured below a first threshold, (ii) Alternate cell RSRP measured higher than a second threshold.

The WTRU may execute a CHO procedure that may be triggered, for example, by detecting that an NTN cell may be unsuitable (e.g., not suitable enough). The WTRU (e.g., executing the CHO procedure) may prioritize executing the CHO/HO towards a stable cell (e.g., before non-stable cells). The WTRU may execute a CHO towards a non-stable cell, for example, (e.g., only) if there are not any stable CHO candidates that meet the CHO conditions.

The WTRU (e.g., based on the WTRU determination of the third alternate TN cell being suitable) may execute a CHO towards the selected candidate and/or may transmit an indication to the third alternate cell. For example, the WTRU may request a full wake-up of the third alternate cell if the third alternate cell is in an NES state. The WTRU may provide the indication, for example, through the transmission of UL WUS signal to the third alternate cell. The third alternate TN cell may be transmitting (e.g., only) SSBs (e.g., slim-SSBs/NCD-SSBs), for example, to enable WTRU monitoring (e.g., hence, a full wake up may be needed for a mobility procedure).

The WTRU may perform mobility (e.g., HO/CHO) to the target cell, for example, based on mobility/CHO conditions being fulfilled for the target cell (e.g., third alternate cell).

The WTRU may (e.g., optionally) provide an indication to the NTN cell, for example, if the CHO not executed (e.g., because the TN did not wake up or the CHO condition(s) did not get fulfilled). The indication may include, for example, a request to modify the current power sharing mechanism.

A benefit/advantage may be that WTRUs can wake up TN cells in deep sleep to monitor and prepare for HO, which may avoid the risk of radio link failure.

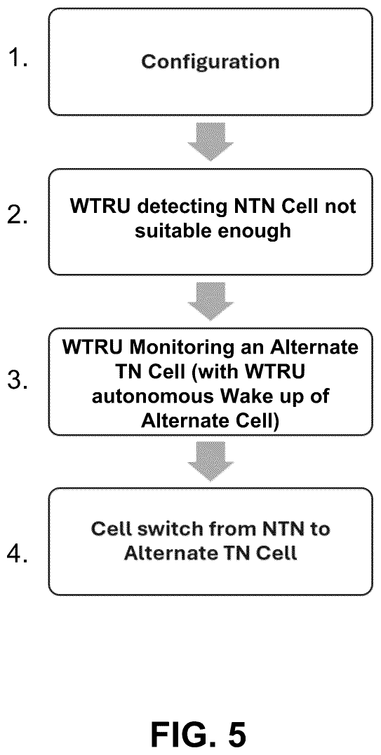

An example (e.g., from a procedural perspective) is shown in FIG. 5.

FIG. 5 illustrates an example of a procedural flow for NTN-TN connected mode mobility in energy saving networks. As shown in FIG. 5 at 1, configuration information may be sent and/or received (e.g., as described herein). As shown in FIG. 5 at 2, the WTRU may detect that the NTN cell is not suitable (e.g., suitable enough). As shown in FIG. 5 at 3, the WTRU may monitor an alternate TN cell (e.g., with WTRU autonomous wake up of an alternate cell). As shown in FIG. 5 at 4, the WTRU may perform a cell switch from the NTN to the alternate TN cell.

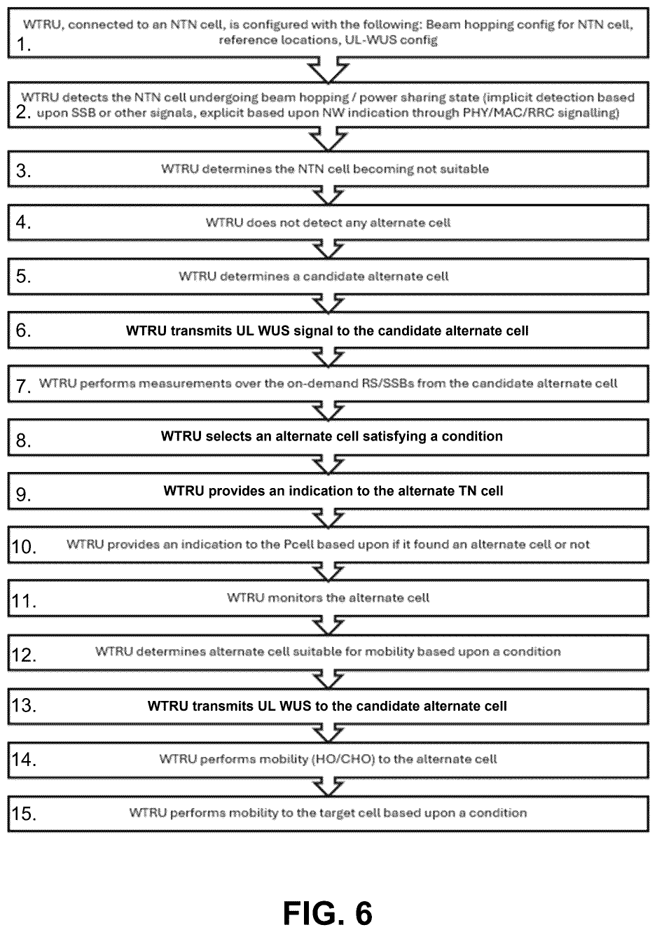

An example of a WTRU performing mobility to an alternate cell is shown in FIG. 6.

FIG. 6 illustrates an example of a WTRU waking up one or more alternate cells, e.g., using a location-based cell-specific WUS, and performing mobility to an (e.g., a suitable) alternate cell. As shown in FIG. 6 at 1, a WTRU (e.g., connected to an NTN cell) may be configured with one or more of the following: beam hopping configuration for NTN cell, reference location(s), UL-WUS configuration information, etc. As shown in FIG. 6 at 2, the WTRU may detect that the NTN cell is undergoing beam hopping/power sharing state (e.g., implicitly based on SSB or other signals or explicitly based on a NW indication (e.g., through PHY/MAC/RRC signaling). As shown in FIG. 6 at 3, the WTRU may determine that the NTN is becoming not suitable. As shown in FIG. 6 at 4, the WTRU may determine that no alternate cell is detected (e.g., does not detect any alternate cell). As shown in FIG. 6 at 5, the WTRU may determine a candidate alternate cell. As shown in FIG. 6 at 6, the WTRU may transmit UL WUS signal to the candidate alternate cell. As shown in FIG. 6 at 7, the WTRU may perform measurements over the on-demand RS/SSBs from the candidate alternate cell. As shown in FIG. 6 at 8, the WTRU may select an alternate cell satisfying a condition. As shown in FIG. 6 at 9, the WTRU may provide an indication to the alternate TN cell. As shown in FIG. 6 at 10, the WTRU may provide an indication to the Pcell, for example, based on if it found an alternate cell or not. As shown in FIG. 6 at 11, the WTRU may monitor the alternate cell. As shown in FIG. 6 at 12, the WTRU may determine an alternate cell suitable for mobility, for example, based on a condition. As shown in FIG. 6 at 13, the WTRU may transmit a UL WUS to the candidate alternate cell. As shown in FIG. 6 at 14, the WTRU may perform mobility (e.g., HO/CHO) to the alternate cell. As shown in FIG. 6 at 15, the WTRU may perform mobility to the target cell, for example, based on a condition.

A WTRU may participate in NTN-TN connected mode mobility in energy saving networks. The term “Network energy saving” may be used to refer to TN and NTN networks. In some deployment examples, the TN and the NTN networks may be operated by a single operator, e.g., where the WTRUs may be allowed (e.g., made to) camp on TN or NTN. In some deployment examples, the TN and NTN may be operated by different operators, e.g., where the WTRUs may be allowed to camp on either of the networks under different types of agreements between the operators. The interactions between TN and NTN networks may (e.g., also) be based on the WTRU subscription.

The term “energy saving state for the cell” may describe the energy saving state for TN and NTN types of cells. Thus, energy saving state may imply, for example, one or more (e.g., any combination) of the following being employed at the cells: power domain adaptations; spatial domain adaptations; cell DTX/DRX; cells transmitting modified forms of common signals/channels (e.g., no SIBs, no SIB1, modified periodicity for SSB, no SSB, modified SSB structure, slim SSB, PBCH less SSB comprising only PSS/SSS, new sync signals, DL-WUS signals only, etc.); beam on/off, for example, if/when a cell (e.g., a satellite) may be turning beams on/off according to a rule (e.g., a periodicity, a pattern, load criteria, etc.); and/or power sharing among different beams, e.g., if/when a cell may be sharing the power among different beams following suitable criteria.

The terms “UL-WUS” or “UL-WUS signal” may describe a signal that a WTRU may be configured to transmit in the UL direction to a cell or satellite beam (e.g., TN and/or NTN) to change/modify/update its network energy saving state. For example, the WTRU may transmit a UL-WUS to wake up a cell in deep sleep mode (e.g., not transmitting any signals). In some examples, the WTRU may transmit a UL-WUS to request SIB (e.g., SIB1) transmissions from a cell that may be transmitting (e.g., only) SSBs. In some examples, the WTRU may transmit a UL-WUS to a cell employing beam power sharing to transmit without beam power sharing, e.g., turning the beam on, or increasing the transmit power of the beam, etc. A UL-WUS may be a request to perform, for example, one or more of the following: wake-up a TN cell, wake up an NTN cell, turn a beam on, increase the transmit power for a beam/cell, update the cell/beam DTX period, etc. The request to wake-up or change the energy saving state to a given state may be known to WTRU/network, for example, through configuration, pre-configuration, specification, and/or indication, e.g., as part of the UL-WUS signaling through implicit or explicit indication.

A WTRU may be configured to support NTN-TN mobility in energy saving networks. For example, a WTRU may receive configuration to support mobility in energy saving networks. A WTRU may receive a configuration, for example, while in connected mode. A WTRU may receive a configuration to support mobility in energy saving networks in idle or inactive mode. The configuration signaling to support mobility may be based on, for example, the RRC state of the WTRU.

In some examples, a WTRU may receive part of a configuration while in a first RRC state (e.g., in connected mode) with one type of the network (e.g., a TN cell or an NTN cell). The NW (e.g., the TN cell or the NTN cell) may (e.g., then) complement, update, or override the configuration for the WTRU while in a second RRC state (e.g., Idle mode). The multiple (e.g., two) RRC states of the WTRU may be the same or different. In some examples, the WTRU may receive part of a configuration from a first cell, which may (e.g., then) be complemented/modified/updated from a different cell (e.g., TN cell or NTN cell). The modification/update of the configuration may happen, for example, after the WTRU performs idle or connected mode mobility to a different cell.

A WTRU may receive a mobility configuration, for example, through one or more of the following signaling methods: cell level broadcast signaling; groupcast signaling (e.g., where the WTRU may be part of the group destined to receive the signaling); WTRU dedicated RRC configuration; dedicated signaling for the WTRU; neighbor cell configuration signaling though the dedicated SIBs or new SIBs; and/or implicit indication through transmission of broadcast signals (e.g., SSB/SIBs, etc.).

A WTRU may receive a mobility configuration comprising, for example, one or more of the following: energy saving configuration; a set of cells (e.g., TN cells or NTN cells or NTN satellite beams); cells' configurations for mobility; reference locations for the cells; measurement configurations for the cells; ephemeris for the cells; service timing for the cells; characteristics of the cells; energy saving state or status for the cells; UL-WUS configuration for the cells; and/or non-cell specific UL-WUS configurations.

A WTRU may receive a mobility configuration comprising an Energy Saving configuration. The WTRU may receive the configuration for network energy saving for one or more cells. An (e.g., each) energy saving configuration may correspond to the energy saving configuration for one or more cells, e.g., the set of serving cells for the WTRU, a set or a subset of neighbor cells that may be (e.g., variously) known and/or unknown to the WTRU.

An energy saving configuration may comprise, for example, one or more of the following mechanisms: beam hopping mechanism for the satellite beams, which may include one or more (e.g., relevant) parameters (e.g., periodicity, active duration, inactive duration, pattern based hopping, pattern indication, etc.); power sharing configuration for the cells (e.g., the NTN cell) or the satellite beams according to a rule, pattern, and/or criterion, with relevant parameters (e.g., power reduction, signals/channels impacted by power reduction); power domain adaptations (e.g., TN or NTN cells); spatial domain adaptations (e.g., corresponding to antenna switching, subset of antenna switching, digital domain or analog domain adaptations, antenna port adaptations, wide or narrow beam adaptations (e.g., for satellite beams), etc.); cell DTX/DRX for TN cells or NTN cells; cells transmitting modified forms of common signals/channels (e.g., no SIBs, no SIB1, modified periodicity for SSB, no SSB, modified SSB structure, slim SSB, PBCH less SSB comprising (only) PSS/SSS, new sync signals, DL-WUS signals only, etc.); and/or beam on/off, for example, if/when a cell (e.g., a satellite) may be turning beams on/off according to a rule (e.g., a periodicity, a pattern, load criteria, etc.).

An energy saving configuration may comprise one or more of the detection mechanisms for a WTRU to detect and/or start/stop/update/modify one or more (e.g., any) of the energy saving mechanisms. A detection mechanism may include one or more (e.g., any) of the following: determination through an implicit indication over (e.g., any) DL signals/channels (e.g., where the information may be derived based on one or more physical properties of the signals/channels); and/or determination through an explicit indication over (e.g., any) DL signals/channels (e.g., where the indication may be carried over (any of) the signals/channels. The signaling may be based on, for example, PHY/MAC/RRC or high layers.

A WTRU may receive a mobility configuration comprising a set of cells (e.g., TN cells, NTN cells, and/or NTN satellite beams). The cells may be neighbor cells to the WTRU or the current serving cell (e.g., or satellite beam), or neighbors to the cell providing the configuration. In some examples, the configuration may indicate the subsequent NTN cells that may provide coverage or that may start to service.

A WTRU may receive a mobility configuration comprising cell configurations for mobility. The network may provide cell configurations for one or more indicated cells. The network may provide cell configurations for L3 or L1/L2 based mobility. The network may provide cell configurations for normal mobility (e.g., L3 or L1/L2 handover) and/or conditional mobility (e.g., L3 or L1/L2). The network may configure (e.g., suitable) execution conditions that may be associated with cell configurations, for example, if/when the network provides the cell configurations in the scope of conditional mobility. The execution conditions may be, for example, radio measurement based (e.g., A3 or A5 events), location based (e.g., WTRU location, satellite location, cell location, etc.), and/or time based. In some examples, the network may provide execution conditions based on one or more of cell characteristics, cell orbits, nature of orbits, etc. In some examples, the execution conditions may be based on WTRU QoS requirements, etc.

A WTRU may receive a mobility configuration comprising reference locations for the cells. The network may provide a set of reference locations for one or more cells indicated to the WTRU. In some examples, the reference locations may be based on 2-D or 3-D locations, which may correspond to the GNSS locations. The reference locations for the cells may correspond to one or more (e.g., any) of the following: cell center, cell boundary, TRP location, and/or a (e.g., suitable) point in the cell coverage or (e.g., any) other (e.g., suitable) representation of the cell or cell coverage. The reference location may be based on a coverage indication. The coverage indication may be provided through different parameter settings. In some examples, the coverage indication for a cell may be indicated by a reference location with a radius. For example, the WTRU may determine itself being in-coverage by determining its location and evaluating whether its distance from the reference location is smaller than the radius. In some examples, different coverage shapes (e.g., polygons, etc.) may be configured for a cell coverage. In some example, the reference locations are provided with reference to the reference location of the serving cell of the WTRU.

A WTRU may receive a mobility configuration comprising measurement configurations for the cells. The network may provide a set of measurement configurations associated with one or more cells (e.g., neighbor cells, TN cells, NTN cells, etc.) for the WTRU to perform measurements. The measurements may be idle/inactive mode or RRC connected mode measurements. The measurement configurations may indicate when the WTRU should perform measurements over one or more of the configurations. The measurements may be based on one or more (e.g., suitable) conditions fulfilled at the WTRU, e.g., WTRU serving cell falls below a threshold, WTRU current cell/beam measurements below a threshold. In some examples, the WTRU may be configured to trigger one or more measurements based on an indication from the network. An indication form the network may include, for example, one or more of the following: detecting a change in (e.g., any of) the energy saving mechanism from a cell (e.g., serving cell, neighbor cell, detected/monitored cell), receiving a request to perform measurements, and/or receiving an indication to validate a set of cells (e.g., TN or NTN cells) for mobility.

A WTRU may receive a mobility configuration comprising ephemeris for the cells: The network may provide the ephemeris information for one or more indicated/configured NTN cells.

A WTRU may receive a mobility configuration comprising service timing for the cells. The network may provide the service time for one or more indicated/configured cells (e.g., NTN cells). The WTRU may use the service time with (e.g., any) other information, e.g., with the measurement configuration.

A WTRU may receive a mobility configuration comprising characteristics of the cells. The network may provide (e.g., additional) features that may be associated with one or more cells, which may include, for example, one or more of the following: the cells being TN cells, the cells being NTN cells, the type/nature of the orbit for the NTN cells (e.g., LEO, MEO, GEO), etc.

A WTRU may receive a mobility configuration comprising energy saving states or statuses for the cells. The network may provide the energy saving state or status (e.g., cell DTX, SSB only cell, modified SSB/slim SSB, beam power sharing, beams illuminating periodically, beam DTX, beams turning on/off, beams turning on/off with specific/configured/indicated patterns) for one or more cells that are indicated/configured to the WTRU. The energy saving state or status of cells may provide parameters relevant to the indicated energy saving state. The network may provide (e.g., further) indication about cells being unavailable, out of service, or shut down after a configured/indicated/specified duration. For example, an NTN cell may provide the configuration of being out of service based on an explicit or implicit indication. For example, cells may not be available, e.g., for one or more (specific) services, for example, due to an (e.g., a specific) energy saving mechanism. In some examples, an NTN cell may configure its use of beam power sharing and/or another (e.g., specific) energy saving mechanism with a start time in the future, e.g., with one or more (appropriate) parameters.

A WTRU may receive a mobility configuration comprising UL-WUS configurations for the cells. The network may provide UL-WUS configuration to the WTRU for one or more cells indicated/configured to the WTRU. The WTRU may use the UL-WUS configuration to request that a cell modify/update its network energy saving state. A request may be, for example, a request to wake-up a TN cell, a request to turn a beam on, a request to increase the transmit power for a beam/cell, a request to update the cell/beam DTX period, etc. In some examples, the cell providing the configuration may provide a UL-WUS configuration for itself, which the WTRU may use, for example, if the WTRU determines to wake up the same cell later. In some examples, the cell providing the UL-WUS configuration may provide a UL-WUS configuration for other cells. A UL-WUS configuration may be, for example, a (e.g., one) UL-WUS configuration for each indicated cell, a (e.g., one) UL-WUS configuration for the cells of a (e.g., one) type (e.g., TN cells or NTN cells).

A WTRU may receive a mobility configuration comprising non-cell specific UL-WUS configurations. The network may provide one or more UL-WUS configurations to the WTRU, which may not be associated with a (e.g., specific) cell. For example, the UL-WUS configurations may have an area scope that may be defined through suitable parameterization. In some examples, the UL-WUS configurations may be associated with one or more geographic areas. In some examples, the UL-WUS configuration may correspond to a WTRU location, e.g., different configurations for different WTRU locations. In some examples, the UL-WUS configuration may be associated with a satellite cell/beam, e.g., the cell/beam of the serving satellite, the cell/beam of a target satellite, or the cell/beam of one or more of indicated satellites. In some examples, the UL-WUS configurations may be associated with a RAN notification area, RAN paging area, tracking area, PLMN, etc. In some examples, the UL-WUS configurations may be associated with one or more (e.g., certain) features of the cells, e.g., TN cells, NTN cells, NTN cells with a specific orbit (e.g., LEO/MEO/GEO, etc.). The network may provide one or more WUS configurations for TN cells, one or more WUS configurations for NTN cells, etc. In some examples, the UL-WUS configurations may be associated with the type of energy saving mechanism that may be used by the cells, e.g., a first UL-WUS configuration for the cells applying power adaptations, a second UL-WUS configuration for the cells transmitting SSB (e.g., or slim SSB) only, a third SSB configuration for the cells transmitting SSB with a reduced periodicity, a forth UL-WUS configuration for the cells in deep sleep (e.g., transmitting no signal at all), a fifth UL-WUS configuration for the cells applying beam hopping, etc.

A WTRU may detect an indication of a cell (e.g., an NTN cell), for example, by applying Beam Hopping or power sharing. A WTRU may detect an indication that a cell is using a form of energy saving mechanism. The WTRU may detect the cell using one or more (e.g., any) of the energy saving mechanisms for a TN cell or for an NTN cell. The WTRU may detect an NTN cell undergoing beam hopping or power sharing among the satellite beams, or (e.g., any) other forms of an energy saving mechanism.

The indication detected by the WTRU may be an implicit indication. The WTRU may detect the implicit indication, for example, by detecting a change in one or more of the DL signal transmissions. The implicit indication may be, for example, one or more of the following: change in the periodicity of an SSB transmission; change in the structure of SSB transmissions (e.g., reduced/modified/SIB1-less SSB, etc.); change in the structure of a system information transmission (e.g., SIB1 not being transmitted, other SIBs not being transmitted); change in one or more of the physical properties of (e.g., common) channels and signals (e.g., SSBs, SIBs, paging channels, etc.); change in the power/spatial domain energy saving mechanism for the cells/beams; change in the cell/beam DTX/DRX (e.g., change in the periodicity, active duration, inactive duration, etc.); and/or change in the beam power sharing (e.g., change in the power level, periodicity, pattern, on/off duration, etc.).

The indication detected by the WTRU may be an explicit indication. The WTRU may detect the explicit indication, for example, by reading one or more (e.g., any) of the DL signals/channels that may be used to carry the indication. The explicit indication may be, for example, one or more of the following: PHY based signaling (e.g., a DCI, a group common DCI); MAC based signaling (e.g., a MAC-CE providing an indication of start, modify, update of one or more (any) of the energy saving techniques; and/or RRC based signaling.

In some examples, the WTRU may be configured to detect the indication in multiple (e.g., two) operations/steps. A first operation may correspond to an explicit or implicit indication. The second operation may correspond to another explicit or implicit indication. In some examples, the first operation may indicate how the WTRU may detect the second operation of the indication. In some examples, the WTRU may be provided with an RRC based configuration in the first operation. The second operation may be based on, for example, a Group common DCI based indication, or an implicit indication by change of SSB periodicity, timing, etc. The first operation (e.g., RRC configuration) may (e.g., also) provide how the WTRU is expected to detect the second step of the indication.

In some examples, the pairs of operations (e.g., first operations and second operations) may be pre-defined, (pre)configured, specified, and/or indicated to the WTRU.

A WTRU may determine that a cell (e.g., an NTN cell) is becoming unsuitable. The WTRU may determine the NTN cell becoming unsuitable (e.g., (a) now, (b) within a window of length T1, (c) after a duration T2) based on, for example, one or more of the following: (i) active QoS requirements, (ii) satellite orbit, (iii) satellite ephemeris, (iv) satellite service time, (v) detected beam hopping pattern (e.g., periodicity larger than a threshold, active time of the beam serving the WTRU smaller than a threshold, etc.), (vi) detected beam power sharing (e.g., power reduction of the satellite beams larger than a threshold, etc.).

A WTRU may determine that a cell is not suitable. The WTRU may determine that a cell is unsuitable for a TN cell or an NTN cell. The WTRU determination may be based on, for example, one or more of the following: active QoS requirements (e.g., if the data rate or latency requirements for the WTRU traffic are not compatible with the energy saving mechanism of the cell); satellite orbit (e.g., LEO/MEO/GEO); satellite ephemeris; satellite service time (e.g., determined (by the WTRU) through explicit signaling (provided by the satellite), through ephemeris (provided by the same or different satellite/cell), or through implicit determination); beam hopping pattern and associated parameters determined by the WTRU (e.g., NTN cell/beam employing beam hopping with periodicity larger than a threshold, active time of the beam serving the WTRU smaller than a threshold, etc.); beam power sharing determined by the WTRU with associated parameters (e.g., power reduction of the satellite beams larger than a threshold, number of re-transmissions required/configured/indicated/scheduled larger than another threshold, etc.); and/or energy saving mechanism determined by the WTRU (e.g., as described herein).

A WTRU determination that a cell may be unsuitable may correspond to, for example, one or more of the following: cell being unsuitable now (e.g., if/when WTRU determines the cell to be unsuitable); cell being unsuitable within a window of duration T1; and/or cell being unsuitable after a duration T2.

A WTRU may (e.g., determine to) monitor a cell, e.g., an alternate cell. An alternate cell may be, for example, one or more of the following cells: a TN Cell; an NTN Cell; a neighbor cell (e.g., any neighbor cell); a detected cell; an indicated/configured cell; not the PCell of the WTRU; and/or not one of the serving cells of the WTRU.

A WTRU may determine a cell (e.g., any cell) to be an alternate cell based on, for example, a condition being fulfilled. The condition may be based on measurements over one or more of the signals transmitted by the cell, e.g., the RSRP of the SSB (e.g., or a suitable RS) is larger than a threshold. The cell may not qualify as an alternate cell for the WTRU, for example, if the condition is not fulfilled. The condition for a cell to qualify as an alternate cell may be, for example, one or more of the following: the measured RSRP of the cell (e.g., over SSB, CSI-RS, any RS) better than a threshold; the measured RSRQ of the cell (e.g., over SSB, CSI-RS, any RS) better than a threshold; the cell location (e.g., the distance between the cell reference location and the WTRU location) is smaller than a threshold; the cell location and a distance, such as a radius (e.g., where the distance between WTRU location and cell location may be smaller than the distance (radius) of the cell); and/or service time, orbit, and/or other (e.g., suitable) indication from the satellite ephemeris for NTN cells.

A WTRU may determine a timing to monitor or start monitoring an alternate cell, for example, based on a condition being fulfilled and/or based on a network providing one or more explicit and/or implicit indications to monitor an alternate cell. The condition(s) may be, for example, one or more of the following: a WTRU determination that the current cell (e.g., TN/NTN cell, PCell, or serving cell) may be unsuitable (e.g., as described herein); a WTRU detection that the current cell (e.g., TN/NTN cell, PCell, or serving cell) may be employing one or more energy saving mechanisms (e.g., as described herein); the WTRU's PCell or serving cell is an NTN cell; the ephemeris of the PCell or serving cell; and/or the service time of the PCell or serving cell, which may indicate that the cell (e.g., NTN Cell) may be going out of service at some time (e.g., now, within a window of time, after a time duration, etc.).

A WTRU may determine a timing when to stop monitoring an alternate cell, for example, based on a condition being fulfilled and/or based on a network providing one or more explicit and/or implicit indications to stop monitoring the alternate cell. The condition(s) may be, for example, one or more of the following: a WTRU determination that the current cell (e.g., TN/NTN cell, PCell, or serving cell) may not be “unsuitable” (e.g., determined as described herein); a WTRU detection that the current cell (e.g., TN/NTN cell, PCell, or serving cell) may not be employing one or more of the energy saving mechanisms (e.g., detected as described herein); the WTRU's PCell or serving cell is an NTN cell; the ephemeris of the PCell or serving cell; and/or the service time of the PCell or serving cell.

In some examples, the WTRU may be configured to monitor (e.g., only) the best cell as an alternate cell, for example, according to one or more conditions, e.g., the cell associated with the largest RSRP/RSRQ measurements. In some examples, the WTRU may be configured to monitor all cells that may qualify as alternate cells (e.g., fulfilling the conditions for being alternate cells). In some examples, the WTRU may be configured to select the best cell according to one or more conditions, and to select one or more other cells that may qualify to be alternate cells.

A WTRU may determine a candidate alternate cell. The WTRU (e.g., if the WTRU does not detect an alternate cell) may determine one or more (e.g., potential) alternate cells based on, for example, one or more of the following: (i) WTRU location, (ii) satellite location, (iii) TN cells reference location(s), (iv) NTN cell ephemeris information, (v) NTN cell/beam NES state, and/or (vi) TN cells NES state. A reference location (e.g., for a TN cell) may be, for example, the location where the coverage of a TN cell may start to become reliable, e.g., to alleviate concerns about sharing TRP locations.

A WTRU may determine a candidate alternate cell. The WTRU may determine a candidate alternate cell based on, for example, one or more of the following as trigger conditions: the WTRU determining to monitor an alternate cell; and/or the WTRU detecting that no cells qualify as alternate cells (e.g., based on the conditions to qualify as alternate cell, for example, as described herein).

A WTRU may determine a cell to be a candidate alternate cell based on, for example, one or more of the following: a WTRU location (e.g., as determined by GNSS or through RAT based positioning); a satellite location (e.g., for the satellite related to WTRU's PCell, serving cell, neighbor cell, or other NTN cells); TN cells reference locations (e.g., the WTRU may have received the reference locations for one or more TN cells with reference locations corresponding to the cells' centers, cells overlapping point with the WTRU's current cell coverage, and/or other (suitable) reference location); NTN cells ephemeris information (e.g., corresponding to the WTRU's PCell, serving cell, neighbor cell), which may be specified, configured, indicated, and/or provided to the WTRU, for example, by the network (e.g., through the PCell, serving cell, or a prior configuration); NTN cell/beam NES state (e.g., detected by the WTRU, as described herein or otherwise); and/or TN cells NES state.

A WTRU may determine a cell to be candidate alternate cell based on, for example, WTRU location and cells reference locations. In some examples, the WTRU may determine a (e.g., one) cell to be a (e.g., potential) alternate cell if the cell's reference location is closest to the WTRU's determined WTRU location.

In some examples, a WTRU may determine a cell to be a candidate alternate cell, for example, if the distance between the cell's reference location and the WTRU location is smaller than a specified/configured/indicated threshold.

In some examples, a WTRU may determine (e.g., all) cells to be candidate alternate cells based on satisfaction of a condition based on WTRU location and cells reference location. In some examples, the WTRU may be configured to select no more than (e.g., at most) “n” cells as candidate alternate cells, where n may be an (e.g., a suitable) integer number. A value of “n” may be configured or indicated to the WTRU.

In some examples, a WTRU may determine a candidate alternate cell based on the ephemeris information of the cell. For example, a WTRU may have information about a set of NTN cells and their ephemeris information. The WTRU may (e.g., then) select a candidate alternate cell among the set of NTN cells based on their ephemeris information. For example, the WTRU may select a candidate NTN cell that may be providing the coverage to the WTRU location or that may provide the coverage to the WTRU location later, e.g., based on satellite ephemeris information, WTRU location, and/or the satellite service time.

A WTRU may transmit a wake-up signal (WUS). In some examples, a WTRU may transmit a WUS to wake-up one or more cells based on the WTRU's mobility configuration. In some examples, the network may provide candidate alternate cells and WUS configurations to the WTRU (e.g., if/when the network responds to the WTRU UL indication, such as described herein or otherwise).

A WTRU may transmit a WUS to a (e.g., specific) cell. The WTRU may transmit a signal, e.g., a wake-up signal, in the UL direction to wake up a candidate alternate cell. In some examples, the WTRU may transmit a WUS to a candidate alternate cell (e.g., determined as described herein). The WTRU may wake-up a candidate alternate cell based on, for example, one or more of the following conditions: the WTRU has not detected an alternate cell; the WTRU has determined candidate alternate cell(s) employing one or more energy saving procedures; the candidate alternate cells are not transmitting SSBs or SIBs (e.g., SIB1, SIB19, etc.); and/or the candidate alternate cells are not receiving some/all signals.

In some examples, a WTRU may transmit a wake-up signal that may not be associated with a (e.g., specific) cell or cell identity, such as if/when the WTRU may have been provided non-cell specific WUS configurations (e.g., as described herein). The WTRU may transmit a WUS, for example, according to a (e.g., suitable) non-cell specific WUS configuration. The WTRU may select the (e.g., suitable) WUS configuration based on, for example, one or more of the following: WTRU location, e.g., associated with non-cell specific WUS configurations directly or indirectly based on a (suitable) area determination, where the WTRU may determine an area based on the location and a WUS configuration associated with the area (e.g., as provided in the configuration); the mobility configuration providing a set of non-cell specific WUS configurations; the network response to the WTRU transmitted UL indication (e.g., as described herein); current cell being an NTN cell or a TN cell; target cells known to be NTN cells or TN cells; target NTN cells being in a specific orbit (e.g., LEO, MEO, GEO, etc.); the detected/known energy saving mechanism/state of the current cell; the detected/known energy saving mechanism/state of the target cells; WTRU detection that the target cells intended for wake-up are transmitting (e.g., only) SSB/SIBs or limited signalling; WTRU detection that the target cells intended for wake-up are not transmitting a signal; and/or information related to a RAN notification area, tracking area, PLMN, etc (e.g., when the WTRU intends to wake up cells in an RNA, TAC, or PLMN) or the WTRU being in an RNA, TAC, PLMN, etc.

A WTRU may transmit a wake-up signal to wake up one or more candidate alternate cells. The wake-up signal may be selected, for example, based on one or more of the following: the identity of the candidate alternate cell (e.g., cell ID, PCI, or other (suitable) identity), for example, if/when the WTRU may (e.g., be able to) determine the identity for a candidate alternate cell; the wake-up signal configuration for the cells that may be received as part of the mobility configuration (e.g., as described herein); WTRU location (e.g., if/when the WTRU may have received WUS configurations that may be associated with an area, WTRU location, etc.); satellite location (e.g., location of satellite for WTRU's PCell, serving cell, and/or candidate alternate cell); and/or ephemeris data (e.g., for the satellite of WTRU's PCell, serving cell, and/or candidate alternate cell).

In some examples, a WTRU may transmit a WUS to wake-up a (e.g., specific) cell (e.g., a cell that the WTRU has determined as a candidate alternate cell). The WTRU may determine the WUS configuration associated with the cell (e.g., candidate alternate cell), for example, if/when the network has provided WUS configurations for one or more cells.

A WTRU may transmit a WUS signal according to its determined WUS configuration. In some examples, the WTRU determined WUS configuration may be for a specific cell. In some examples, the WTRU determined WUS configuration may not be for a specific cell, e.g., the WTRU may (be configured to) determine a suitable configuration based on WTRU location, area, RNA, TAC, PLMN ID, etc.

In some examples, a WTRU may transmit a WUS to wake-up one or more cells. The WTRU may transmit WUS to wake-up one or more cells, for example, in order to receive on-demand RS (e.g., SSB, CSI-RS, RSs, etc.) transmission from the one or more cells. The WTRU may (e.g., then) use the measurements, for example, to determine one or more alternate cells (e.g., as described herein).

In some examples, a WTRU may transmit a WUS to wake-up one or more cells. The WTRU may transmit a WUS to wake-up one or more cells that the WTRU may have determined as alternate cells (e.g., as described herein). The WTRU may make one or more (e.g., initial) measurements over the RSs transmitted by the cells, e.g., prior to transmitting a WUS to the cells. In some examples, the network may instruct a set of cells to transmit RSs over which the WTRU may make measurements, e.g., to select an alternate cell. In some examples, the cells may transmit RSs in response to another WTRU transmitting a WUS to the cells. The WTRU may provide an indication to the alternate cells, for example, by transmitting a WUS to the alternate cells. This indication may imply a request for the alternate cells to stay awake, e.g., subsequently. The WUS may be an indication to the alternate cell(s) that the WTRU has determined the cell(s) to be the alternate cell(s). The WTRU may monitor the alternate cell (e.g., subsequently), for example, as described herein.

In some examples, a WTRU may transmit a WUS to wake-up one or more cells. The WTRU may transmit a WUS to wake up one or more cells while the cells may be the alternate cells for the WTRU. In some examples, the cells may be in a partial energy saving state, e.g., performing limited transmission/reception. The WTRU may monitor the alternate cells, for example, through their transmission of RSs, e.g., SSBs. The WTRU may transmit the WUS to wake up one or more of the alternate cells in preparation for a mobility procedure. For example, the WTRU may be configured with one or more measurement conditions for the alternate cell and/or the serving cell. The WTRU may (e.g., determine to) wake up the alternate cell, for example, if/when the one or more conditions are fulfilled. The WTRU wake up of the alternate cell (e.g., based on reception of the WUS) may be an indication for the cell that the WTRU intends to perform a mobility procedure (e.g., CHO) to the alternate cell.

The WTRU transmitted UL WUS signal may be, for example, one or more of the following: a RACH transmission (e.g., the RACH configuration may be a dedicated or a common configuration); an SRS transmission over the configured/dedicated/indicated resource; and/or the transmission of a general/specific RS that may be configured to be used as a WUS signal.

A WTRU may detect a wake-up of one or more cells. A WTRU may detect a wake-up of one or more cells based on, for example, the WTRU's transmission of WUS signal (e.g., as described herein).

The WUS signals may be cell specific WUS signals or non-cell specific WUS signals (e.g., location/area specific, RNA/TAC/PLMN specific). The WTRU may be configured to detect one or more signals (e.g., SSB/CSI-RS/other reference signals) from a cell to consider the wake-up of the cell. The WTRU may be configured to detect the signals from a cell with a (e.g., specific) timing, for example, with respect to the WTRU's WUS transmission, e.g., no earlier than a time duration after WTRU WUS transmission, within a window of configured duration after WUS transmission, after a time threshold after the WUS transmission, a combination of multiple timings, etc.

A WTRU may detect wake-up of one or more cells, for example, based on an indication received from the network.

A network (NW) may wake up cells based on WTRU assistance. The WTRU may detect wake-up of a cell, for example, based on a detection of a signal/channel transmission, e.g., a detection of SSB/SIB1/SIBs/CSI-RS or other (suitable) RS from a cell. The WTRU (e.g., upon determining the wake-up of one or more cells) may determine whether to make measurements over the cells. The WTRU may determine if any of the cells may qualify as alternate cells (e.g., as described herein).

A WTRU may provide an indication to a cell, e.g., an alternate cell. The WTRU may provide an indication to the WTRU's alternate cell, for example, to prepare for an (e.g., eventual) mobility procedure. The indication to the WTRU's alternate cell may comprise, for example, one or more of the following: a stay-awake request; an identity of the WTRU's current PCell or serving cell; and/or a cause.

An indication from a WTRU to an alternate cell may include a stay-awake request. For example, the WTRU may transmit a stay awake request to the alternate cell so that the cell continues to transmit one or more (e.g., suitable) RSs (e.g., SSBs, SIBs, CSI-RS, etc.), which may allow the WTRU to monitor the cell.

An indication from a WTRU to an alternate cell may include an identity of the WTRU's current PCell or serving cell.

An indication from a WTRU to an alternate cell may include a cause, which may indicate one or more reasons why WTRU is waking up the cell, e.g., previous PCell going to sleep, going in NES mode, using an (a specific) NES mode, etc.

A WTRU may provide a UL indication to the WTRU's current serving cell. A WTRU may provide an indication to a cell, e.g., the WTRU's PCell, or current serving cell. The WTRU may provide indication to the WTRU's PCell or serving cell based on, for example, one or more conditions being fulfilled. The condition(s) may comprise, for example, one or more of the following: the WTRU detects the WTRU's PCell or serving cell going into an energy saving, power sharing, or beam hopping mode (e.g., as described herein); the WTRU determines that the cell is unsuitable (e.g., as described herein); the WTRU does not detect an alternate cell (e.g., according to the conditions for an alternate cell); the WTRU does not detect a (e.g., any) candidate alternate cell; the WTRU does not have a suitable WUS configuration to wake up neighbor cells; the WTRU fails to detect a cell wake-up after the WTRU's WUS transmission (e.g., after one WUS transmission, after all WUS transmissions, or after the WTRU has transmitted WUS to the maximum number of repetitions allowed but still fails to detect a cell waking up); the WTRU fails to wake up a cell for a mobility procedure; and/or the WTRU fails to perform a CHO to a target cell.

The WTRU may provide an indication to the WTRU's PCell or serving cell. The indication may comprise, for example, one or more of the following: WTRU location; WTRU request for the network to wake up cells which are neighbor to the WTRU; WTRU request for the network to provide WUS configurations for the cells in proximity to the WTRU; identity of one or more alternate cells; identity of one or more candidate alternate cells; and/or a roll-back request.

An indication from a WTRU to the WTRU's PCell or serving cell may include a WTRU location.

For example, the WTRU may provide WTRU location to the cell to enable the network to wake up suitable cells around the WTRU, to request suitable WUS configurations for the neighboring cells, etc.

An indication from a WTRU to the WTRU's PCell or serving cell may include a WTRU request for the network to wake up cells that may be neighbors to the WTRU. The WTRU may be configured to transmit the request and/or to expect the network initiated wake-up of the cells around the WTRU, e.g., to find alternate cells, etc.

An indication from a WTRU to the WTRU's PCell or serving cell may include a WTRU request for the network to provide WUS configurations for the cells in proximity to the WTRU, for example, so that the WTRU may wake up the cells around the WTRU to determine alternate cells for monitoring, etc.

An indication from a WTRU to the WTRU's PCell or serving cell may include an identity of one or more alternate cells. The WTRU may determine the alternate cells according to one or more rules (e.g., as described herein).

An indication from a WTRU to the WTRU's PCell or serving cell may include an identity of one or more candidate alternate cells. The WTRU may determine candidate alternate cells, for example, as described herein.

An indication from a WTRU to the WTRU's PCell or serving cell may include a roll-back request. The WTRU may provide an indication for the network to roll-back the network's energy saving mechanism/procedure. The WTRU may (e.g., determine to) transmit the roll-back request to the network based on, for example, one or more of the following: WTRU determination that the network has started or is starting to use energy saving (e.g., power sharing, beam hopping, etc.); WTRU determination that the cell is not suitable; WTRU failure to detecting an alternate cell; WTRU failure to detect a candidate alternate cell; and/or WTRU not having any WUS configurations or a suitable WUS configuration.

In some examples, a WTRU may (e.g., be configured to) provide an indication to the network based on a WTRU determination that the current cell is unsuitable (e.g., as described herein). The indication may comprise, for example, assistance information to the network, e.g., WTRU location, expected traffic/flows, traffic/flow QoS requirements, etc.

The WTRU may transmit a UL indication through a (e.g., suitable) signalling method. For example, the WTRU may be configured to use RRC signalling, MAC signalling, or PHY signalling to provide the UL indication.

In some examples, a WTRU may be configured to use a signalling method based on the information indicated in the indication. For example, a first type of signalling may be configured/indicated if the WTRU provides the cell identities of the alternate cells, a second type of signalling method may be configured/indicated if the WTRU provides the WTRU's location, a third type of signalling method may be configured if/when WTRU provides a roll-back request to the network for an energy saving mechanism, etc.

In some examples, a WTRU may be configured to select a signalling method based on the size of the information (e.g., the number of information bits) in the UL indication. For example, the WTRU may be configured to use a first type of signalling method if the number of information bits is smaller/larger than a threshold or within a known/configured range, a second type of signalling method based on the number of information bits relative to the same or different threshold or range, etc.

A WTRU may receive an indication (e.g., or response) from the network (e.g., in response to the WTRU's UL indication). The WTRU may receive the indication (e.g., or response) from the network based on, for example, the WTRU's UL indication transmission (e.g., as described herein). The WTRU may receive, for example, one or more of the following in the network response: an indication of one or more cells that the network may be waking-up; measurement configurations for one or more cells; one or more WUS configurations for the cells in proximity to the WTRU; cells configurations for one or more cells; and/or a response to a roll-back request.

The network response to the WTRU may include an indication of one or more cells that the network may be waking-up. The network may provide an indication of one or more cells (e.g., cell IDs, PCIs, etc.) that the network may be waking up in response to the WTRU. The network indication/response may provide additional parameters, e.g., frequencies of the cells, time/frequency locations of SSBs, parameters for a window (e.g., start time, end time) where WTRU may detect and measure the cells, etc.

The network response to the WTRU may include measurement configurations for one or more cells. In some examples, the WTRU may use the measurement configurations to validate/detect network-based wake-up. In some examples, the WTRU may detect the wake-up of one or more cells using the measurement configurations subsequent to the WTRU's UL WUS transmission. The measurement configurations may be associated with an SSB (e.g., cell defining SSB, non-cell defining SSB, slim SSB etc), CSI-RS, or other suitable RSs. The measurement configurations may be based on RSs that may be periodic in nature or may be based on on-demand transmission of RSs. The on-demand transmission of RSs may be for one-shot transmission, transmission of “N” instances, transmission within a window of time, etc.

The network response to the WTRU may include one or more WUS configurations for the cells in proximity to the WTRU (e.g., so that the WTRU may wake up the cells around the WTRU to determine alternate cells for monitoring, etc.). The WTRU may receive the conditions based on which the WTRU may use the WUS configurations, e.g., time, location or measurement-based conditions, etc.

The network response to the WTRU may include cells configurations for one or more cells (e.g., so that the WTRU may perform a mobility procedure to the one or more cells).

The network response to the WTRU may include a response to a roll-back request. The network may provide a response to WTRU's request to roll-back an energy saving mechanism. The network may provide a binary information, e.g., yes or no, to the WTRU request. In some examples, the network may update the energy saving parameters and provide the updated parameters to the WTRU in the response. The network may (e.g., also) indicate additional parameters, e.g., if/when the updated parameters become valid, etc.

In some examples, a WTRU may receive an indication of one or more cells that the network may be waking-up. The network may provide the indication of one or more cells based on the WTRU indication, which may comprise WTRU assistance information, e.g., WTRU location. The network may provide an indication of one or more cells (e.g., cell IDs, PCIs, etc.) that the network may wake up in response. The network may provide additional parameters, e.g., frequencies of the cells, time/frequency locations of SSBs, parameters for a window (e.g., start time, end time) where the WTRU may detect and measure the cells, etc.

In some examples, a WTRU may receive an indication of one or more UL-WUS configurations for the cells. The network may provide a UL-WUS configuration of one or more cells based on the WTRU indication, which may comprise WTRU assistance information, e.g., WTRU location. The WUS configurations may correspond to the cells in proximity to the WTRU, for example, so that the WTRU may wake up the cells around the WTRU, e.g., to determine alternate cells for monitoring, etc. The WTRU may receive the conditions based on which the WTRU may use the WUS configuration, e.g., time, location, and/or measurement-based conditions.

In some examples, a WTRU may receive an indication of one or more cells and one or more UL-WUS configurations. The network may indicate a temporary wake-up of the cells for the transmission of RSs, e.g., on-demand SSB/CSI-RS or other (suitable) RSs. The WTRU may be configured to measure the RSs. The WTRU (e.g., based on the measurements) may determine a (e.g., suitable) cell, such as an alternate cell (e.g., as described herein). The WTRU may (e.g., then) select the UL-WUS configuration for the determined alternate cell. The WTRU may wake up the determined alternate cell, for example, by transmitting a UL-WUS to the alternate cell.

The WTRU may monitor an Alternate Cell. The WTRU (e.g., upon determining a cell to be an alternate cell) may monitor the alternate cell. The WTRU may monitor a cell, for example, by making measurements over one or more (e.g., some) signals transmitted by the cell. The WTRU may (e.g., be configured to) perform periodic, semi-persistent, and/or aperiodic measurements to monitor a cell, e.g., an alternate cell. In some examples, the WTRU may monitor a cell by making the same measurements as configured for the link monitoring and/or for beam monitoring for beam failure and recovery. In some examples, the WTRU may (e.g., be configured to) perform the same measurements as configured for intra-frequency cells, inter-frequency cells, inter-band cells, etc.

A WTRU may perform measurements based on (pre)configuration. The measurements may be for intra-frequency, inter-frequency, and/or inter-RAT measurements. These measurements may be for detected cells, configured cells, and/or indicated cells. The WTRU may make measurements over SSBs, CSI-RS, discovery signals, and/or any other type of reference signals.

The measurement configurations may comprise, for example, one or more of the following: measurements objects, measurement signals to use, time/frequency resource indication, periodicity of signals, QCL properties, etc. The WTRU may be configured to make measurements, for example, for one or more of the following quantities: SS reference signal received power (SS-RSRP); CSI reference signal received power (CSI-RSRP); SS reference signal received quality (SS-RSRQ); CSI reference signal received quality (CSI-RSRQ); SS signal-to-noise and interference ratio (SS-SINR); CSI signal-to-noise and interference ratio (CSI-SINR); SRS reference signal received power (SRS-RSRP); Received Signal Strength Indicator (RSSI); DL PRS reference signal received power (DL PRS-RSRP); and/or DL reference signal time difference (DL RSTD).

A WTRU may apply compensation to measurements. The WTRU may update the measured or estimated quantities from the received radio signals. The WTRU may update the measurements based on, for example, the network energy saving state.

A WTRU may perform mobility to a target cell. The target cell may be an alternate cell or a candidate alternate cell. In some examples, the target cell may be woken up by the WTRU through the transmission of a UL WUS signal. In some examples, the target cell may be woken up by the network, e.g., when the network may wake-up one or more cells based on a WTRU providing a UL indication to the WTRU's current serving cell (e.g., as described herein). The UL indication may include, for example, WTRU assistance information (e.g., location), a WTRU indication that the current cell may be unsuitable, etc. The network (e.g., based on the WTRU's UL indication) may wake up suitable cells around the WTRU location and/or the network may provide (e.g., suitable) WUS configurations to the WTRU to wake up cells autonomously.

In some examples, a WTRU may transmit a WUS to wake-up a cell (e.g., an alternate cell) based on, for example, a WTRU determination to perform mobility to the alternate cell as a target cell. The WTRU wake up of the alternate cell (e.g., receiving the WUS) may be an indication for the cell that WTRU intends to perform a mobility procedure (e.g., CHO) to the alternate cell.

The mobility to an alternate cell may be a handover (HO) or a conditional handover (CHO). The WTRU may perform mobility based on, for example, one or more conditions being fulfilled. The condition(s) may be, for example, one or more of the following: measurement(s) of the PCell or PSCell falling below one or more thresholds; measurement(s) of the target cell better than one or more thresholds; a condition based on reference locations (e.g., a WTRU location, reference location 1, and reference location 2); a condition based on time; the energy saving state of the PCell; and/or the energy saving state of the target cell.

The WTRU may perform mobility based on satisfaction of one or more conditions that may include measurement(s) of the PCell or PSCell falling below one or more thresholds (. g., the RSRP/RSRQ of the PCell or PSCell may fall below a configured/indicated threshold).

The WTRU may perform mobility based on satisfaction of one or more conditions that may include measurement(s) of the target cell better than one or more thresholds (e.g., the RSRP/RSRQ of the target cell may be measured to be better than a configured/indicated threshold). The target cell may be an alternate cell, a candidate alternate cell, etc.

The WTRU may perform mobility based on satisfaction of one or more conditions that may include a condition based on reference locations (e.g., a WTRU location, reference location 1, and reference location 2). A reference-location condition may be satisfied, for example, if the WTRU distance is closer to reference location 2 than reference location 1, where the reference location 1 may correspond to a reference location of the WTRU's PCell or PSCell and reference location 2 may correspond to a target cell.

The WTRU may perform mobility based on satisfaction of one or more conditions that may include a condition based on time. The time may correspond to, for example, the service time of the PCell and/or the service time of the target cell.

The WTRU may perform mobility based on satisfaction of one or more conditions that may include the energy saving state of the PCell.

The WTRU may perform mobility based on satisfaction of one or more conditions that may include the energy saving state of the target cell.

A handover (HO) to NTN may be triggered by a TN cell entering an NES state. In some examples, a WTRU may be connected to an TN cell. The WTRU may be configured with a set of CHO configurations for NTN cells and/or frequencies with their NES states, beam hopping patterns, measurement configurations, reference locations, etc. The WTRU may know a subset of NTN cells that may be “stable”, e.g., that may not be in an NES state. The stable NTN cells may be configured as CHO candidates. The WTRU may measure the stable NTN cells first, e.g., prior to measuring other NTN cells that may may be “unstable.” The WTRU may (e.g., also) be configured with and/or may determine that a subset of CHO NTN candidates may be available (e.g., only) at per determined time periods (e.g., as a function of a periodic pattern, which may be similar to a cell DTX pattern).

In some examples, the NES activation signaling (e.g., a bit in the DCI or a DCI indication, or a DCI format that may be associated with an NES or an NES RNTI) may indicate to the WTRU to prioritize one or more (e.g., certain) CHO candidates (e.g., NTN cells or TN cells, a group of CHO candidates, cells based on their energy saving state etc.). The WTRU may determine that an NTN cell may be prioritized, for example, based upon the NES activation signaling and the NTN cell satisfying the criterion indicated by the NES activation signaling. The WTRU may determine the NTN cell satisfying the criterion based upon the cell configuration, frequency ranges or based upon signals received from one or more cells.

The WTRU (e.g., once the WTRU detects the TN cell has activated an NES state or may be in an active NES state) may start monitoring an alternate NTN Cell, e.g., if an alternate TN cell or stable TN cell is not found to meet handover conditions. The WTRU may be configured with a list of CHO candidate to prioritize for measurement and execution, for example, once the serving source TN cell activates NES. For example, the WTRU may attempt to find at least one CHO candidate that is a TN cell and stable. The WTRU may (e.g., then) attempt to find at least one CHO candidate that is a TN cell in an NES state (e.g., unstable). The WTRU may (e.g., then) attempt to find at least one CHO candidate that is an NTN cell and deemed satisfactory/good enough.

In some examples, the WTRU may attempt to find at least one CHO candidate that is an NTN cell and deemed satisfactory/good enough prior to attempting to find at least one CHO candidate that is a TN cell in an NES state (e.g., unstable). The WTRU may be configured with a list of frequencies or frequency ranges (FRs) to prioritize (e.g., for NTN), for example, when measuring, evaluating, and executing handover conditions.

A WTRU (e.g., based on a determination that a TN cell is unsuitable) may (e.g., first) search for an alternate TN cell (e.g., stable or not in an active NES state) for handover (e.g., by performing mobility related measurements). The WTRU may attempt to measure TN cells that are in an NES state, for example, if the WTRU does not detect an alternate TN cell not in an NES state. The WTRU may attempt to measure NTN cells, for example, if the WTRU does not detect an alternate TN cell.

The WTRU may delay the CHO execution towards a candidate (e.g., NTN CHO candidate) until (e.g., all) the NTN cells are measured, e.g., provided the candidates have different availability periods (e.g., given a cell DTX pattern). The WTRU (e.g., once (all) the NTN cells are measured within a cell DTX pattern periodicity) may (e.g., then) execute a CHO towards the best measured CHO candidate (e.g., the CHO candidate that best meets the condition(s)), for example, after reception of the CHO execution bit in the DCI activating an NES state. The WTRU may execute the handover, for example, after the WTRU detects an alternate (e.g., CHO candidate, such as an NTN) cell satisfying one or more conditions, e.g., RSRP is above a threshold.

In some examples, the WTRU may wake up a TN cell (e.g., only) if the WTRU has not found an alternative NTN cell (e.g., CHO candidate) that meets handover conditions. The WTRU may determine a candidate alternate TN cell (e.g., a non-stable TN cell), for example, if the WTRU does not detect an alternate cell (e.g., NTN or TN that is stable). The WTRU may determine a candidate alternate TN cell (e.g., a non-stable TN cell), based on, for example, one or more of the following: (i) WTRU location, (ii) satellite location, (iii) TN cells reference locations, (iv) NTN cells ephemeris information, (v) NTN cell/beam NES state, and/or (vi) TN cells NES state. The WTRU (e.g., based on the determination of a candidate alternate TN cell) may transmit a UL WUS signal, for example, using the UL WUS configuration that may be associated with the selected candidate alternate TN cell. The WTRU (e.g., based on the measurements) may select an alternate TN cell satisfying one or more conditions, e.g., RSRP is above a certain threshold.

The WTRU (e.g., prior to handover to an NTN cell) may provide an indication to the WTRU's TN source cell about the identity of the alternate NTN cell and/or a reason, such as an indication that a suitable TN alternate cell and/or stable TN cell was not found.

A WTRU may wake up an alternate cell using, for example, a cell-specific WUS.

A WTRU may wake up an alternate cell using, for example, a location based cell specific WUS, e.g., based on a detection of NTN power sharing.

A WTRU may be connected to a serving cell. For example, the WTRU may be connected to a serving cell that is an NTN cell. A WTRU connected to an NTN cell may be configured with, for example, one or more of the following: an NTN power sharing mechanism, a set of neighbor TN cells, associated WUS configurations, and/or mobility/CHO configurations for neighboring TN cells. The WTRU may be configured with an associated NES state, a reference location, and/or a UL WUS configuration, for example, for a (e.g., each) TN cell. A WTRU (e.g., upon detecting an NTN cell applying beam hopping/power sharing) may determine one or more candidate alternate TN cells to monitor, for example, based on one or more of the following: (i) WTRU location, (ii) satellite location/ephemeris, (iii) TN cells reference locations, (iv) NTN cell NES state, (v) TN cells NES states, and/or (vi) measurement of channel conditions of neighbor cells (e.g., TN cells). The WTRU may wake up the selected candidate alternate TN cell, for example, by transmitting a UL-WUS according to the received configuration. The WTRU may make measurements on the (e.g., on-demand) SSBs (e.g., RSs) from the candidate alternate cell. The WTRU may (e.g., start to) monitor for a potential cell switch. The WTRU may perform mobility (e.g., HO/CHO) to the alternate cell, for example, based on a condition, e.g., HO/CHO conditions being fulfilled.

A WTRU may receive a configuration and/or configuration information. A WTRU (e.g., connected to an NTN cell) may be configured, for example, with one or more of the following: a beam hopping/power sharing indication configuration for an NTN cell; a set of CHO configurations for TN cells with their NES states, measurement configuration, and/or reference locations; and/or a set of UL-WUS configurations that may be associated with one or more of the neighbour TN cells or WTRU locations, or the satellite location/ephemeris, etc. For example, the configuration information may indicate a first TN network. The configuration information may indicate one or more of an NES state associated with the first TN cell, a first reference location associated with the first TN cell, and/or a WUS configuration associated with the first TN cell.

A WTRU (e.g., connected to an NTN cell) may be configured with a beam hopping/power sharing indication configuration for an NTN cell.

A WTRU (e.g., connected to an NTN cell) may be configured with a set of CHO configurations for TN cells with their NES states, measurement configuration, and/or reference locations. The WTRU may know a subset of TN cells that may be “stable” (e.g., TN cells that may not be in an NES state). Stable cells may be configured as CHO candidates. The WTRU may measure the stable cells (e.g., first) prior to measuring other TN cells that are “not stable” “unstable.”

A WTRU (e.g., connected to an NTN cell) may be configured with a set of UL-WUS configurations that may be associated with one or more of the neighbor TN cells or WTRU locations, or the satellite location/ephemeris, etc.

A WTRU may detect whether an NTN Cell is or is not suitable. For example, the WTRU may determine that a serving cell is not suitable based on a determination that a condition is satisfied. The WTRU may detect the NTN cell undergoing a beam hopping/power sharing state (e.g., satisfying a condition). Implicit detection may be based on detecting a change in a measurement or one of the physical properties of signal, for example, an SSB and/or other signals. Explicit detection may be based on, for example, a NW indication, e.g., through PHY/MAC/RRC signalling.

The WTRU may determine the NTN cell becoming unsuitable (e.g., (a) now, (b) within a window of length T1, (c) after a duration T2) based on, for example, one or more of the following: (i) active QoS requirements, (ii) satellite orbit, (iii) satellite ephemeris, (iv) satellite service time, (v) detected Beam hopping pattern (e.g., periodicity larger than a threshold, active time of the beam serving the WTRU smaller than a threshold, etc), (vi) detected beam power sharing (e.g., power reduction of the satellite beams larger than a threshold, etc), (vii) a measurement on a reference signal from the serving cell.

A WTRU may monitor an alternate (e.g., first alternate) TN cell (e.g., WTRU autonomous wake up of alternate cell). For example, a WTRU (e.g., based on a determination that an NTN cell may be unsuitable) may (e.g., first) search for a first alternate TN cell for handover (e.g., by performing mobility related measurements) that may be “stable,” e.g., not in an active NES state. The WTRU may attempt to measure TN cells that are in an NES state, for example, if the WTRU does not detect a first alternate TN cell that is not in an NES state For example, the WTRU may determine that a first alternate cell is not suitable for handover. The WTRU may determine that the first alternate cell is not suitable for handover based on a determination that a second condition is satisfied. The first alternate cell may include the first TN cell (e.g., as indicated by configuration information).

The WTRU (e.g., if the WTRU does not detect a first alternate cell) may determine a second alternate (e.g., candidate alternate) cell (e.g., a non-stable TN cell), for example, based on one or more of the following: (i) WTRU location, (ii) satellite location, (iii) TN cells reference locations, (iv) NTN cells ephemeris information, (v) NTN cell/beam NES state, and/or (vi) TN cells NES state. A TN cell reference location may be the TRP location for the TN cell, geographic centre of the TN cell coverage, or a suitable location where the coverage of the TN cell may start to become reliable.

The WTRU (e.g., based on the determination of a second alternate (e.g., candidate alternate) TN cell) may transmit a UL WUS signal, e.g., using the UL WUS configuration that may be associated with the selected candidate alternate TN cell. The WTRU may send the UL WUS signal to the second alternate cell (e.g., candidate alternate cell). The WTRU may determine the UL WUS configuration, for example, based on one or more of a WTRU location, a satellite location associated with an NTN cell, satellite ephemeris information, or a reference location. The WUS configuration may be an area-specific WUS configuration.

The WTRU (e.g., within a window T after UL WUS transmission) may detect/perform measurements over the on-demand RS/SSBs from the second alternate cell (e.g., candidate alternate cell).

The WTRU (e.g., based on the measurements) may select an alternate TN cell (e.g., third alternate cell) that satisfies one or more conditions, e.g., RSRP/RSRQ is above a certain threshold.

The WTRU may provide an indication to the third alternate TN cell to stay awake.

The WTRU may provide an indication to its serving about the identity of the third alternate TN cell.

The WTRU may, e.g., alternatively, report that the WTRU did not find a “suitable” alternate cell.

The WTRU may request NTN Power Sharing Rollback, for example, if the WTRU did not find an alternate cell. The WTRU may not find a suitable alternate cell, for example, if there is not a TN cell in proximity of the WTRU.

The WTRU may (e.g., start to) monitor the third alternate TN cell.

The WTRU may perform a cell switch from the NTN to the third alternate TN Cell. The WTRU may determine that the third alternate TN cell is suitable for mobility (e.g., HO/CHO), for example, based on a determination that a third condition (e.g., associated with the serving cell or the third alternate cell) is satisfied. The WTRU may determine that the third alternate TN cell is suitable for mobility (e.g., HO/CHO), for example, based on one or more conditions being fulfilled, e.g., (i) NTN cell RSRP measured below a first threshold, (ii) Alternate cell RSRP measured higher than a second threshold.

The WTRU may execute a CHO procedure that may be triggered, for example, by detecting that an NTN cell may be unsuitable (e.g., not suitable enough). The WTRU (e.g., executing the CHO procedure) may prioritize executing the CHO/HO towards a stable cell (e.g., before non-stable cells). The WTRU may execute a CHO towards a non-stable cell, for example, (e.g., only) if there are not any stable CHO candidates that meet the CHO conditions.

The WTRU (e.g., based on the WTRU determination of the third alternate TN cell being suitable) may execute a CHO towards the selected candidate and/or may transmit an indication to the third alternate cell. For example, the WTRU may request a full wake-up of the third alternate cell if the third alternate cell is in an NES state. The WTRU may provide the indication, for example, through the transmission of UL WUS signal to the third alternate cell. The third alternate TN cell may be transmitting (e.g., only) SSBs (e.g., slim-SSBs/NCD-SSBs), for example, to enable WTRU monitoring (e.g., hence, a full wake up may be needed for a mobility procedure).

The WTRU may perform mobility (e.g., HO/CHO) to the target cell, for example, based on mobility/CHO conditions being fulfilled for the target cell (e.g., third alternate cell).

The WTRU may (e.g., optionally) provide an indication to the NTN cell, for example, if the CHO not executed (e.g., because the TN did not wake up or the CHO condition(s) did not get fulfilled). The indication may include, for example, a request to modify the current power sharing mechanism.

A benefit/advantage may be that WTRUs can wake up TN cells in deep sleep to monitor and prepare for HO, which may avoid the risk of radio link failure.

An example (e.g., from a procedural perspective) is shown in FIG. 5.

FIG. 5 illustrates an example of a procedural flow for NTN-TN connected mode mobility in energy saving networks.

An example of a WTRU performing mobility to an alternate cell is shown in FIG. 6.

FIG. 6 illustrates an example of a WTRU waking up one or more alternate cells, e.g., using a location-based cell-specific WUS, and performing mobility to an (e.g., a suitable) alternate cell.

NTN-TN connected mode mobility in energy saving networks may be implemented, for example, by using an area-specific WUS. A WTRU may determine an alternate cell, for example, using an area-specific WUS.

A WTRU connected to an NTN cell may be configured with an NTN power sharing mechanism, a set of neighbor TN cells, and/or mobility/CHO configurations for neighboring TN cells. The WTRU may be provided with a set of area-specific UL-WUS configurations.

The WTRU may detect an NTN cell applying beam hopping/power sharing. The WTRU (e.g., upon detecting an NTN cell applying beam hopping/power sharing) may determine a suitable area-specific WUS configuration based on, for example, one or more of the following: (i) WTRU location, (ii) satellite location/ephemeris, (iii) NTN cell NES state, and/or (iv) TN cells NES states. The WTRU may transmit a UL-WUS, for example, according to the determined configuration. The WTRU may make one or more measurements on the (e.g., on-demand) SSBs (e.g., RSs) from the cells that wake up upon receiving the WTRU transmitted WUS. The WTRU may determine an alternate cell based on, for example, one or more conditions, e.g., RSRP better than a threshold. The WTRU may monitor the alternate cell. The WTRU may perform mobility (/CHO) to the alternate cell based on, for example, one or more conditions, e.g., CHO conditions getting fulfilled.

A WTRU (e.g., connected to an NTN cell) may be configured, for example, with one or more of the following: a beam hopping/power sharing indication configuration for an NTN cell; a set of CHO configurations for TN cells (e.g., with their NES states and/or measurement configurations); and/or a set of UL-WUS configurations linked to the reference areas and/or satellite beams (e.g., reference locations, RNA, TAC, and/or PLMN, etc.).

A WTRU may detect that an NTN Cell may be unsuitable (e.g., not suitable enough).

The WTRU may detect the NTN cell undergoing a beam hopping/power sharing state. For example, an implicit detection may be based on SSB or other signals. An explicit detection may be based on an NW indication, e.g., through PHY/MAC/RRC signalling.

The WTRU may determine that the NTN cell is becoming unsuitable (e.g., (a) now, (b) within a window of length T1, (c) after a duration T2) based on, for example, one or more of the following: (i) active QoS requirements, (ii) satellite orbit, (iii) satellite ephemeris, (iv) satellite service time, (v) detected Beam hopping pattern (e.g., periodicity larger than a threshold, active time of the beam serving the WTRU smaller than a threshold, etc.), (vi) detected beam power sharing (e.g., power reduction of the satellite beams larger than a threshold, etc.).

The WTRU may determine an alternate cell, for examples, by using an area-specific WUS.

The WTRU may determine that an NTN cell is unsuitable. The WTRU (e.g., based on the determination that the NTN cell is unsuitable), may detect an alternate TN cell that satisfies one or more conditions, e.g., RSRP is above a threshold.

The WTRU may determine a suitable UL-WUS configuration, for example, if the WTRU does not detect an (e.g., any) alternate TN cell. The WTRU may determine a (e.g., suitable) UL-WUS configuration based on, for example, one or more of the following: (i) WTRU location, (ii) satellite location, (iii) satellite ephemeris information, (iv) a reference location (e.g., associated with RNA/TAC/PLMN), etc.

The WTRU may transmit a UL WUS signal using, for example, the determined UL WUS configuration.

The WTRU (e.g., within a window T after UL WUS transmission) may detect and/or perform measurements over the on-demand RS/SSBs from one or more cells.

The WTRU (e.g., based on the measurements) may select an alternate TN cell satisfying one or more conditions, e.g., RSRP is above a threshold.

The WTRU may provide an indication to the selected alternate TN cell to stay awake.

The WTRU may provide an indication to the WTRU's NTN PCell about the identity of an alternate TN cell. The WTRU may report that an alternate cell was not found, e.g., if that's the case. The WTRU may request an NTN Power Sharing Rollback, for example, based on one or more conditions, e.g., no alternate cell found.

The WTRU may (e.g., start to) monitor the alternate TN cell.

A WTRU may participate in a cell switch from NTN to an alternate TN cell.

The WTRU may determine that an alternate TN cell is suitable for mobility (/CHO), for example, based on fulfilment of one or more conditions, e.g., (i) NTN cell RSRP falling below a threshold, (ii) alternate cell RSRP better than a second threshold.

The WTRU (e.g., based on the WTRU determination that an alternate TN cell may be suitable) may transmit an indication to the alternate cell, e.g., requesting a full wake-up of the alternate cell. The WTRU indication may be provided, for example, through the transmission of a UL WUS signal to the alternate cell.

The alternate TN cell may be transmitting (e.g., only) SSBs (e.g., slim-SSBs/NCD-SSBs) to enable WTRU monitoring. Hence, a full wake up may be needed for a mobility procedure.

The WTRU may perform mobility (e.g., HO/CHO) to the target cell based on, for example, one or more mobility/CHO conditions getting fulfilled for the target cell.

The WTRU may provide an indication to the NTN cell for a failure to execute/complete the CHO, for example, if the TN cells do not wake up and/or CHO conditions are not fulfilled for a determined alternate cell. The WTRU may request the NTN cell to modify the current power sharing mechanism.

A benefit/advantage of NTN-TN connected mode mobility in energy saving networks, e.g., using an area-specific WUS, may be that a WTRU can wake up TN cells in deep sleep to monitor and prepare for an HO, which may avoid the risk of radio link failure.

NTN-TN connected mode mobility in energy saving networks may be implemented, for example, by a network assisted determination of an alternate cell based on WTRU assistance Information.

A WTRU connected to an NTN cell may be configured with, for example, an NTN power sharing mechanism, a set of neighbor TN cells, and/or one or more mobility/CHO configurations for one or more neighboring TN cells. The WTRU may detect the NTN cell applying beam hopping/power sharing. The WTRU (e.g., upon detecting the NTN cell applying beam hopping/power sharing) may provide assistance information to the network, which may comprise, for example, one or more of the following: (i) WTRU location, (ii) satellite location/ephemeris, etc. The WTRU may receive an indication from the network, which may comprise, for example, the identities of the TN cells (e.g., candidate alternate cells), measurement configurations, and/or UL-WUS configuration for the indicated cells. The WTRU may make one or more measurements on the (e.g., on-demand) SSBs (e.g., RSs) transmitted by the indicated cells. The WTRU may determine an (e.g., a suitable) alternate cell. The WTRU (e.g., upon determining the suitable alternate cell) may (e.g., start to) monitor the cell. The WTRU may perform mobility (e.g., HO/CHO) to the alternate cell, for example, based on fulfillment of one or more conditions, e.g., CHO conditions getting fulfilled.

A WTRU (e.g., connected to an NTN cell) may be configured with, for example, one or more of the following: a beam hopping/power sharing indication configuration for the NTN cell; and/or a set of CHO configurations for TN cells, e.g., with their NES states, measurement configurations, etc.

The WTRU may detect that the NTN cell is unsuitable (e.g., not suitable enough). For example, The WTRU may detect the NTN cell undergoing a beam hopping/power sharing state. An implicit detection may be based on an SSB or other signals. An explicit detection may be based on an NW indication, e.g., through PHY/MAC/RRC signalling.

The WTRU may determine the NTN cell becoming unsuitable (e.g., (a) now, (b) within a window of length T1, (c) after a duration T2) based on, for example, one or more of the following: (i) active QoS requirements, (ii) satellite orbit, (iii) satellite ephemeris, (iv) satellite service time, (v) detected beam hopping pattern (e.g., periodicity larger than a threshold, active time of the beam serving the WTRU smaller than a threshold, etc.), (vi) detected beam power sharing (e.g., power reduction of the satellite beams larger than a threshold, etc.).

The WTRU may monitor an alternate TN cell, which may be identified, for example, by network assisted determination based upon WTRU assistance information (e.g., based on the WTRU sending assistance information).

The WTRU may determine an NTN cell to be unsuitable. The WTRU (e.g., based on determining the NTN cell is no longer suitable) may detect an alternate TN cell satisfying one or more conditions, e.g., RSRP is above a threshold.

The WTRU may provide an indication to the NTN Cell (e.g., including WTRU location), for example, if the WTRU does not detect an (e.g., any) alternate TN cell. The WTRU may send assistance information to the serving cell. The assistance information may include WTRU location information.

The network (e.g., in response) may provide an indication of one or more TN cells to monitor (e.g., through an on-demand RS/SSB). The network may provide measurement configurations and/or UL-WUS configurations for the indicated cells.

The WTRU (e.g., within a window T after receiving the network indication) may perform one or more measurements over the on-demand RS/SSBs from one or more indicated cells.

The WTRU (e.g., based on the measurements) may select an alternate TN cell, for example, based on satisfaction of one or more conditions, e.g., RSRP is above a threshold.

The WTRU may provide an indication to the alternate TN cell to stay awake. The WTRU may provide a stay awake indication, for example, by transmitting a UL-WUS to the alternate cell.

The WTRU may provide an indication to the WTRU's NTN PCell about the identity of the alternate TN cell. The WTRU may report that an alternate cell was not found, e.g., if that's the case. The WTRU may request an NTN Power Sharing Rollback based on one or more conditions, e.g., no alternate cell found.

The WTRU may (e.g., start to) monitor the alternate TN cell.

The WTRU may participate in a cell switch from the NTN to the alternate TN cell.

The WTRU may determine that the alternate TN cell is suitable for mobility (HO/CHO), for example, based on fulfilment of one or more conditions, e.g., (i) NTN cell RSRP falling below a threshold, (ii) alternate cell RSRP better than a second threshold, etc.

The WTRU (e.g., based on the WTRU determination that the alternate TN cell may be suitable) may transmit an indication to the alternate cell, e.g., requesting a full wake-up of the alternate cell. The WTRU indication may be provided, for example, through the transmission of a UL WUS signal to the alternate cell.

The alternate TN cell may be transmitting (e.g., only) SSBs (e.g., slim-SSBs/NCD-SSBs) to enable WTRU monitoring. Hence, a full wake up may be needed for a mobility procedure.

The WTRU may perform mobility (e.g., HO/CHO) to the target cell based on, for example, mobility/CHO conditions getting fulfilled for the target cell.

The WTRU may provide an indication to the NTN cell for a failure to execute/complete the CHO, which may occur, for example, if the TN cells do not wake up, do not pass the alternate cell conditions, and/or if one or more CHO conditions are not fulfilled for a determined alternate cell. The WTRU may request the NTN cell to modify the current power sharing mechanism.

A benefit/advantage of NTN-TN connected mode mobility in energy saving networks, e.g., using a network assisted determination of an alternate cell based on WTRU assistance Information, may be that the WTRU can wake up TN cells in deep sleep to monitor and prepare for an HO, which may avoid the risk of radio link failure.

A WTRU may may detect that an NTN cell is applying beam hopping/power sharing. The WTRU (e.g., upon detecting the NTN cell applying beam hopping/power sharing) may try to determine and wake up an alternate cell(e.g., as described herein), for example, by a WTRU-initiated UL-WUS transmission.

A failure event may occur, for example, if the WTRU does not have one or more (e.g., suitable) WUS configurations to wake up one or more candidate alternate cells, if the candidate cells do not wake up, if the measurements on the candidate cells' reference signals do not meet the alternate cell criterion, etc. The WTRU (e.g., in case a failure event occurs) may participate in determining and waking up an alternate cell, e.g., as described herein with assistance by the network based on WTRU provided assistance information.

A WTRU may (e.g., be configured to) perform or participate in NTN-TN connected mode mobility in energy saving networks, for example, by determining an alternate cell using an area-specific WUS and/or using a network assisted determination of the alternate cell based on WTRU assistance Information. For example, a WTRU may (e.g., be configured to) determine an alternate cell using an area-specific WUS if there is not a failure event and/or using a network assisted determination of the alternate cell based on WTRU assistance Information if there is a failure event.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor.

Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is:

1. A wireless transmit/receive unit (WTRU) connected to a serving cell, the WTRU comprising:
a processor configured to:
receive configuration information, wherein the configuration information indicates a first terrestrial network (TN) cell;
determine that the serving cell is not suitable based on a determination that a first condition is satisfied, wherein the serving cell is a non-terrestrial network (NTN) cell;
determine that a first alternate cell is not suitable for handover based on a determination that a second condition is satisfied, wherein the first alternate cell is the first TN cell;
based on the determination that the first alternate cell is not suitable for handover, determine a second alternate cell as a candidate alternate cell, wherein the second alternate cell is a second TN cell; and
transmit a wake-up signal (WUS) to the second alternate cell.

2. The WTRU of claim 1, wherein the processor is further configured to:
perform a measurement associated with the second alternate cell;
determine a third alternate cell based on the measurement; and
monitor the third alternate cell.

3. The WTRU of claim 2, wherein the measurement is a reference signal received power (RSRP) measurement, wherein the measurement is performed within a duration after the transmission of the WUS, and wherein the processor is further configured to:
determine that the RSRP measurement is greater than a threshold, wherein the third alternate cell determined based on the measurement is based on the determination that the RSRP measurement is greater than a threshold.

4. The WTRU of claim 2, wherein the processor is further configured to:
send an indication to the serving cell that indicates an identity of the third alternate cell; and
send an indication to the third alternate cell indicating to stay awake.

5. The WTRU of claim 2, wherein the processor is further configured to:
determine that a third condition is satisfied, wherein the third condition is associated with at least one of the serving cell or the third alternate cell;
based on the determination that the third condition is satisfied, determine that the third alternate cell is suitable for mobility; and
based on the determination that the third alternate cell is suitable for mobility, perform at least one of,
a handover to the third alternate cell, or
a transmission of an indication to the third alternate cell, wherein the indication requests a wake-up of the third alternate cell if the third alternate cell is in an NES state.

6. The WTRU of claim 1, wherein the second alternate cell is determined based on one or more of a WTRU location, a satellite location associated with an NTN cell, a TN cell reference location, NTN cell ephemeris information, an NTN cell network energy savings (NES) state, an NTN beam NES state, or a TN cell NES state.

7. The WTRU of claim 1, wherein the first condition is associated with a measurement on a reference signal from the serving cell, an active quality of service (QoS) requirement, a satellite orbit, satellite ephemeris information, a satellite service time, a beam hopping pattern, or beam power sharing.

8. The WTRU of claim 1, wherein the configuration information further indicates one or more of a network energy savings (NES) state associated with the first TN cell, a first reference location associated with the first TN cell, or a WUS configuration associated with the first TN cell.

9. The WTRU of claim 1, wherein the WUS is transmitted using a WUS configuration, and wherein the processor is further configured to:
determine the WUS configuration, wherein the WUS configuration is determined based on one or more of a WTRU location, a satellite location associated with an NTN cell, satellite ephemeris information, or a reference location, wherein the WUS configuration is an area-specific WUS configuration.

10. The WTRU of claim 1, wherein to determine the second alternate cell, the processor is further configured to:
send assistance information to the serving cell, wherein the assistance information includes WTRU location information; and
receive, from the serving cell, an indication indicating the second alternate cell, wherein the second alternate cell is determined based on the indication.

11. A method comprising:
a processor configured to:
receiving configuration information, wherein the configuration information indicates a first terrestrial network (TN) cell;
determining that a serving cell is not suitable based on a determination that a first condition is satisfied, wherein the serving cell is a non-terrestrial network (NTN) cell;
determining that a first alternate cell is not suitable for handover based on a determination that a second condition is satisfied, wherein the first alternate cell is the first TN cell;
based on the determination that the first alternate cell is not suitable for handover, determining a second alternate cell as a candidate alternate cell, wherein the second alternate cell is a second TN cell; and
transmitting a wake-up signal (WUS) to the second alternate cell.

12. The method of claim 11, wherein method further comprises:
performing a measurement associated with the second alternate cell;
determining a third alternate cell based on the measurement; and
monitoring the third alternate cell.

13. The method of claim 12, wherein the measurement is a reference signal received power (RSRP) measurement, wherein the measurement is performed within a duration after the transmission of the WUS, and wherein method further comprises:
determining that the RSRP measurement is greater than a threshold, wherein the third alternate cell determined based on the measurement is based on the determination that the RSRP measurement is greater than a threshold.

14. The method of claim 12, wherein method further comprises:
sending an indication to the serving cell that indicates an identity of the third alternate cell; and
sending an indication to the third alternate cell indicating to stay awake.

15. The method of claim 12, wherein method further comprises:
determining that a third condition is satisfied, wherein the third condition is associated with at least one of the serving cell or the third alternate cell;
based on the determination that the third condition is satisfied, determining that the third alternate cell is suitable for mobility; and
based on the determination that the third alternate cell is suitable for mobility, performing at least one of,
a handover to the third alternate cell, or
a transmission of an indication to the third alternate cell, wherein the indication requests a wake-up of the third alternate cell if the third alternate cell is in an NES state.

16. The method of claim 11, wherein the second alternate cell is determined based on one or more of a wireless transmit/receive unit (WTRU) location, a satellite location associated with an NTN cell, a TN cell reference location, NTN cell ephemeris information, an NTN cell network energy savings (NES) state, an NTN beam NES state, or a TN cell NES state.

17. The method of claim 11, wherein the first condition is associated with a measurement on a reference signal from the serving cell, an active quality of service (QoS) requirement, a satellite orbit, satellite ephemeris information, a satellite service time, a beam hopping pattern, or beam power sharing.

18. The method of claim 11, wherein the configuration information further indicates one or more of a network energy savings (NES) state associated with the first TN cell, a first reference location associated with the first TN cell, or a WUS configuration associated with the first TN cell.

19. The method of claim 11, wherein the WUS is transmitted using a WUS configuration, and wherein the method further comprises:
determining the WUS configuration, wherein the WUS configuration is determined based on one or more of a WTRU location, a satellite location associated with an NTN cell, satellite ephemeris information, or a reference location, wherein the WUS configuration is an area-specific WUS configuration.

20. The method of claim 11, wherein to determine the second alternate cell, the method further comprises:
sending assistance information to the serving cell, wherein the assistance information includes wireless transmit/receive unit (WTRU) location information; and
receiving, from the serving cell, an indication indicating the second alternate cell, wherein the second alternate cell is determined based on the indication.
